(19) United States
(12) Patent Application Publication
(10) Pub. No.: US 2014/0222444 A1
(43) Pub. Date: Aug. 7, 2014

(54) Method And System For Clinical Trial Management

(71) Applicant: DIXIT S.R.L., Torino (IT)

(72) Inventors: Piergiorgio Cerello, Torino (IT); Stéphane Chauvie, Torino (IT); Andrea Gallamini, Torino (IT); Alexandru Mihail Cristian Stancu, Torino (IT)

(73) Assignee: DIXIT S.R.L., Torino (IT)

(21) Appl. No.: 13/757,912

(22) Filed: Feb. 4, 2013

(51) Int. Cl. G06Q 10/00; G06Q 50/22; G06F 19/00

(52) U.S. Cl. CPC G06Q 10/00; G06F 19/36; G06Q 50/22
USPC 705/2

(57) ABSTRACT

A method of managing a clinical trial includes verifying compliance with pre-determined data collection protocols in real time of medical data collected by peripheral clinical trial centers participating in the clinical trial, sending compliance verifications, collecting review reports submitted by the reviewers on the medical data, such as medical imaging data, according to a predetermined question-and-answer format, evaluating the answers in the review reports, for concordance, and transmitting at least one electronic notification pertaining to a result obtained from the evaluating, wherein at least one of the verifying, sending, collecting, evaluating, and transmitting is performed using at least one processor. A system for implementing the method also is provided.

### FIELD OF THE INVENTION

The present invention relates to a method for clinical trial management. The present invention further relates to a computerized system for clinical trial management.

### BACKGROUND OF THE INVENTION

Clinical trials are a set of procedures that are conducted in medical research and drug development in order to collect safety and efficacy data for health interventions (e.g., drugs, diagnostics, devices, therapy protocols). Clinical trials typically can start only after satisfactory information on the patient or subject safety (treatment, drug, side effects, etc.) throughout the clinical trials process has been gathered and health authorities/ethics committees approval is granted in the countries where the clinical trial takes place.

To ensure that the results of the clinical trials are reliable and reproducible, many clinical trials are often multi-site and/or multi-national operations which typically require substantial planning and oversight to run efficiently. For example, a clinical trial may involve hundreds or thousands of patients recruited worldwide, and a central management service may be employed to manage various aspects of the clinical trial.

As clinical trials continue to grow in complexity and global scope, the processes required to manage such studies are becoming more sophisticated and the volume and/or complexity of data generated by the numerous sites, organizations, and systems involved in large clinical trials increases. To manage this added complexity investigational sites often employ multiple technology systems within a single clinical trial to perform their responsibilities, with each of the systems being designed to provide a specific function to facilitate the operation of the clinical trial. For example, one application may be designed for data acquisition and management, whereas another application may be designed for trial control and logistics (e.g., randomization and trial supply management). Other applications may be designed for planning and administration or data analysis and reporting. Individual applications are often selected based on their own relative merits in comparison to the alternatives, rather than being selected based on their ability to integrate with other applications.

The present investigators have recognized that in current clinical trials, only a random control of the peripheral centers is performed, and that manner of operation, which moreover is expensive, does not allow real time verification of the correctness of the data used in the trials even while being costly. The present investigators have further recognized that there is a need for a method which can provide verification in real time of all or selected data collected by peripheral clinical trial centers, thus allowing for enhanced compliance control of the centers and diagnosis accuracy based on data collected from subjects at the centers. Besides, there is a need of quality control and consistency checks on the diagnosis provided by reviewers/assessors from patient recruiting centers, with the goal of tracking down Progression vs. Regression of disease over the trial course.

### SUMMARY OF THE INVENTION

A feature of the present invention is a method to (1) manage a clinical trial by which personnel at multiple clinical trial sites, off-site administrators and reviewers involved in a common clinical trial are able to remotely access functionality and/or clinical data and images through a common interface; (2) manage the clinical trial workflow, the quality of generated images and data in an analytical and stepwise fashion, allowing a superior reliability and reproducibility of the results required to evaluate the effectiveness of a drug or medication treatment.

A further feature of the present invention is a method which uses a web-based system for real time, centralized workflow protocol auditing over multiple clinical trial sites involved in a clinical trial, and which provides web-based data, images and diagnosis exchange to obtain pooled and concordance-assessed reviews of multiple off-site reviewers within short-time frames, with minimal (or no additional) on-site hardware or software deployment being required by users of the system.

Another feature of the present invention is a method of using a computer system for setting up and implementing workflow corresponding to the protocol of a clinical trial, wherein the study can involve many sites and requires clinical data exchange, image central review by specialists and diagnosis exchange for centralized concordance evaluation within controlled time frames.

A further feature of the present invention is a method for managing a clinical trial that permits remote access to imaging data via an Internet connection and a browser without requiring onsite hardware or software deployment beyond a non-specific image-viewer software for medical diagnosis data reviewers and permits a workflow to be configured to set up a network of specialists for diagnosis exchange.

A further feature of the present invention is a computerized system for implementing the methods.

To achieve these and other advantages and in accordance with the purposes of the present invention, as embodied and broadly described herein, the present invention relates, in part, to a method of managing a clinical trial, comprising a) verifying compliance with pre-determined data collection protocols in real time of at least one type of medical data, such as patient clinical and/or imaging data, collected on a clinical trial from at least one of a plurality of peripheral clinical trial centers participating in the clinical trial; b) sending, upon verifying compliance in a), electronic notifications to a plurality of reviewers of the availability of the patient clinical and/or imaging data or other medical data for review by the reviewers; c) collecting reports submitted by the reviewers via an electronic form, wherein the review reports comprise answers of the reviewers to a common predetermined set of diagnosis questions about the patient clinical and/or imaging data or other medical data; d) evaluating the answers in the review reports, for concordance; and e) transmitting at least one electronic notification pertaining to a result obtained from the evaluating, wherein at least one of the verifying, sending, collecting, evaluating, and transmitting is performed using at least one processor.

The present invention also relates to a computerized method for managing a clinical trial, comprising: a) accessing a gateway to a central server computer on a computer system via the Internet from at least one remote client computer having a web browser, wherein the server computer comprises a processor operable to run a program loadable on the processor for managing workflow of a clinical trial, wherein the clinical trial involves a plurality of physically separate sites from which imaging study images obtained on subjects in the clinical trial are to be generated for image and diagnosis exchange; b) inputting details at the server computer to configure a workflow program for a clinical trial to be managed on the computer; c) designating users for the workflow program under different categories of users, each category of user being granted different respective categories of access to the workflow program; d) populating subject lists for the workflow program; e) calibrating image quality control for the clinical trial to be managed using the workflow program; f) configuring the QA (Quality Assurance before study onset) and QC (Quality Control during clinical trial) requirements related to calibrating image quality in every single site participating to the clinical trial; g) uploading an imaging study by logging into the gateway to the central server computer; h) auditing an imaging study uploaded to the workflow program in real time, to determine a successful imaging study submission, wherein the auditing comprises at least one procedure of checking digital communication in medicine compliance, checking patient file anonymity, checking protocol compliance, and checking time-frame of reporting; i) sending, upon determining a successful imaging study submission in step h), notifications to designated image reviewers, designated laboratory users, contract research organization users, a principal investigator, a workflow administrator, or any combinations thereof; j) logging into the gateway to the central server computer, by each of the notified image reviewers, via the Internet; k) downloading at least one respective imaging study image by each of the notified image reviewers, onto a respective remote client computer; l) reviewing, by each of the notified reviewers, at least one downloaded image using a non-specific image viewing software selected by the respective reviewer; m) inputting, by each of the notified image reviewers, responses into a report form having a preselected question-and-answer format, which is accessed using the workflow program, for data entry capture using a remote client computer having a web browser; n) evaluating the answers in the report forms of the notified image reviewers for concordance; o) evaluating the consensus result of the report forms according to the rules specified by the clinical trial protocol; and p) transmitting at least one electronic notification pertaining to the consensus result obtained from the evaluating, to at least one of an investigator or system administrator of the clinical trial.

The present invention also relates to a clinical trial management system, comprising: a server computer comprising at least one processor; at least one remote client computer having a display and a web browser and which can access the server computer via the Internet, wherein the at least one processor is operable to generate at least one user interface on a display of a remote data entry device configured to provide a user access to at least one clinical trial function via the at least one user interface, the at least one processor is operable to run a program loadable on the server computer for managing workflow of a clinical trial that comprises a plurality of physically separate sites from which medical data obtained on patients in the clinical trial are generated for data and diagnosis exchange, and the at least one processor is operable to run the program for automatically: a) verifying compliance with pre-determined data collection protocols in real time of at least one type of medical data collected on a clinical trial patient from at least one of a plurality of peripheral clinical trial centers participating in the clinical trial; b) sending, upon verifying compliance in a), electronic notifications to a plurality of reviewers of the availability of the medical data for review by the reviewers; c) collecting reports of the reviewers based on an analysis of the medical data by the reviewers, the reports comprising answers to a common predetermined set of diagnosis questions about the medical data; d) evaluating the answers for concordance; e) evaluating the consensus according to the rules defined in the clinical trial protocol; and f) transmitting at least one electronic notification pertaining to the consensus result obtained from the evaluating.

The present invention also relates to a non-transitory device or means configured for implementing the indicated methods of the present invention.

As used herein, the phrase “clinical trial” or “trial” can refer to any of a variety of different testing procedures, phases, or studies relating to therapeutic and/or prophylactic drug therapies, treatments, and/or medical devices, which are suited for use with human beings, animals, microorganisms, and the like. The present invention also can be used in the context of observational studies, registry studies, outcome studies, consumer evaluations of products, and/or pre-clinical lab and/or animal research.

As used herein “subjects” or “patients” are the subjects enrolled in the clinical trial, undergoing the diagnosis examinations, such as imaging-based examinations or measurements of clinical observables, and the subjects can be human patients or other types of patients, such as laboratory test animals.

As used herein, “Internet” refers to a collection of networks which facilitates the sharing of resources among participating organizations, including government agencies, educational institutions and private corporations, wherein these networks use the Transmission Control Protocol/Internet Protocol (TCP/IP) protocol suite and share a common address space. Thus, computers on the Internet use compatible communications standards and share the ability to contact each other and exchange data. Users of the Internet can communicate via electronic mail or “e-mail” (e.g., via SMTP), via short message service (SMS), via Telnet, a process that allows users to log in to a remote host for bi-directional communication sessions, and via implementations of the File Transfer Protocol (FTP), a protocol that allows the users to transfer information on a remote host to their local site. Hypertext Transfer Protocol (HTTP) is a known protocol intended for quick-access, distributed, collaborative, hypermedia systems. This is the standard protocol of the World Wide Web (WWW or more simply the “Web”). HTTPS or HTTP over SSL (Secure Socket Layer) is a known variant of HTTP which provides enhanced security.

As used herein “concordance” can refer to a statistical measure of how much scores or measurements produced by different reviewers agree. Concordance may be expressed as a number between 0 and 1, where 0 represents no agreements at all, and 1 represents complete agreement, or other measures of agreement.

The following abbreviations may be used herein: AAIS: Action After Imaging Study; ABIS: Action Before Imaging Study; BICR: Blinded Independent Central Review; BTV: Biological Tumor Volume; CAD: Computer Assisted Detection, CECT: Contrast Enhanced Computed Tomography; CLT: Clinical Trial; CL: Core Laboratory; CR: Combined Report; CRO: Contract Research Organization; CRS: Combined Report Score; CT: Computed Tomography; CTO: Clinical Trial Operations; CTOM: Clinical Trial Operation Monitoring; CTS: Clinical Trial Status; CTV: Clinical Tumor Volume; DICOM: DIgital COmmunication in Medicine; DMT: System Medical Team; DST: System Software Team; FAQ: Frequently Asked Questions; FDG: Fludeoxyglucose; FFS: Failure-Free Survival; FI: Functional Imaging; GCP: Good Clinical Practices; GTV: Gross Tumor Volume; HIPAA: Health Insurance Portability and Accountability Act; iCLT: imaging-based Clinical Trial; iCRO: imaging Contract Research Organization; IGART: Image Guided Adapted Radiation Therapy; IGS: Imaging Generating Sites; IM: Imaging Modality; IP: Imaging Protocol; IR: Imaging Report; IS: Imaging Study; ISET: Imaging Study Expected Time; ISN: Imaging Study Number; ISR: Imaging Study Rank; ISV: Imaging Study Validation; MR: Magnetic Resonance; MRD: Minimal Residual Disease; MRI: Magnetic Resonance Imaging; NPV: Negative Predictive Value; NR: Notification Rank; NnTE: Notification non-Trigger Event; NTE: Notification Trigger Event; OS: Operating System; P4: Plug-and-Play PET Phantom; PET: Positron Emission Tomography; PFS: Progression-Free Survival; PI: Principal Investigator; PPID: Post-Processed Image Data; PPV: Positive Predictive Value; PV: Protocol Violation; Q2: Qualification Quantification; QA: Quality Assurance; QC: Quality Control; QP: Qualification Process; RC: Recovery Coefficient; RCR: Reviewers Concordance Rate; RID: Reconstructed Image Data; ROC: Receiver Operator Characteristic; RP: Review Panel; RWF: Report Web Form; SC: Session Coordinator; SD: Standard Deviation; SQ: Site Qualification; SQP: Site Qualification Process; SRP: Standard Reporting Procedure; SUV: Standardized Uptake Value; TIC: Trial Imaging Coordinator; TOR: Time Of Recruitment; UWF: Upload Web Form; US: Ultra-Sonography; VC: Validation Checks; VoI: Volume of Interest; VPN: Virtual Private Network; WCL: system core laboratory; and WUS: system User Support.

It is to be understood that both the foregoing general description and the following detailed description are exemplary and explanatory only and are intended to provide a further explanation of the present invention, as claimed.

### BRIEF DESCRIPTION OF THE DRAWINGS

The accompanying figures, which are incorporated in and constitute a part of this application, illustrate various features of the present invention and, together with the description, serve to explain the principles of the present invention. The features depicted in the figures are not necessarily drawn to scale. Similarly numbered elements in different figures represent similar components unless indicated otherwise.

FIG. 1 shows of a system for managing a clinical trial over a communications network according to an example of the present application.

FIG. 2 shows of a system for managing a clinical trial over the Internet according to an example of the present application.

FIGS. 3A and 3B show a process flow diagram of a method according to an example of the present application.

FIG. 4A shows a table that the system displays on a user's device for data entry of information related to CLT Mode parameters related to the global imaging-related features of the CTP that forms part of defining protocols of a clinical trial according to an example of the present application.

FIG. 4B shows a table that the system displays on a user's device for data entry of basic information to be used to overview the CLT Imaging Protocol and provide a first assessment on its technical feasibility that forms part of defining protocols of a clinical trial according to an example of the present application.

FIG. 4C shows a table that the system displays on a user's device for data entry to define notification protocols of a clinical trial according to an example of the present application.

FIG. 4D shows a table that the system displays on a user's device for data entry to be used as part of site qualification processing in the management of a clinical trial according to an example of the present application.

FIG. 4E shows a table that the system displays on a user's device for data entry used as part of a developer validation checklist for all the CLT required workflow functionality in the development and management of a clinical trial according to an example of the present application.

FIG. 5 shows a chart of workflow related to a clinical trial pre-recruitment phase in which clinical trial, imaging, and reviewer protocols are defined for setting qualifications of clinical trial site enrollment, imaging data collection, and imaging study review rules according to an example of the present application.

FIG. 6 shows a schematic of a suite of program building blocks or modules that can be offered by the system to a clinical trial principal investigator, or system administrator working in conjunction with the principal investigator, which various modules can be selected during preclinical trial development of protocols for the trial according to an example of the present application.

FIG. 7 shows a schematic of a clinical trial workflow during a clinical trial using the system according to an example of the present application.

FIG. 8 shows a schematic of workflow for auditing for clinical trial protocol compliance during a clinical trial according to an example of the present application.

FIG. 9 shows a multiparametric table than can be used in the system according to an example of the present application.

FIG. 10 shows a schematic of a review process/workflow of an imaging study on the system according to an example of the present application.

FIG. 11 shows an exemplary screen shot of an interface that can provided on a remote device for logging into the system via a web portal (website) according to an example of the present application.

FIG. 12 shows an exemplary screen shot of an interface that can provided on a remote device for uploading imaging data of an imaging study to the server of the system according to an example of the present application.

FIG. 13 shows an exemplary screen shot of an interface that can provided on a remote device for notifying reviewers with links to a compliant submitted imaging study for review according to an example of the present application.

FIG. 14 shows an exemplary screen shot of an interface that can provided on a remote device for a review to download an image study according to an example of the present application.

FIG. 15 shows an exemplary screen shot of an interface that can provided on a remote device of a reviewer using a reviewer-selected image viewing software to evaluate the images within a prescribed timeframe according to an example of the present application.

FIG. 16 shows an exemplary screen shot of an interface that can provided on a remote device for reviewer entry of evaluation answers into report form of the system according to an example of the present application.

### DETAILED DESCRIPTION OF THE INVENTION

The present invention provides a method and system for managing clinical trials in a networked computing environment. The method can provide verification in real time of all or selected data collected by a plurality of peripheral clinical trial participating centers, thus allowing for enhanced control of the centers compliance to the CLT protocol across the entire trial duration. Capability is provided to readily verify that any one or all the peripheral clinical trial centers are correctly applying required steps and protocols relating to the collection of data at the trial centers while also providing for centralized data review and automated reviewer auditing. Interactions with the clinical trial management system can be performed from peripheral sites over a computer communications network, such as the Internet, and recorded in and distributed from (as needed) a central data store and/or database in a highly automated manner. Quality control auditing also can be applied by the clinical trial management system in a highly automated manner.

In an example, a Web-based approach for managing aspects of a clinical trial is provided that allows trial participating personnel, such as administrators, investigators, sponsors, reviewers, and the like, to communicate with a centralized system using a computer system and appropriate Internet browser. The remote users can easily access and interface with a centralized server, such that users may only need an Internet connection, a browser and a non-specific image viewer. The system does not require onsite hardware or software deployment amongst the users or such deployment can be minimized (e.g., web browsers and/or image review software in the case of reviewers, often may be preloaded on the users' communication devices independent of participation in the system), which can provide rapid, less costly and frictionless deployment, adoption and usage.

The method and system of the present invention for handling the workflow and quality control on multi-center clinical trials, such as presented herein, can allow a much more reliable management of the clinical trial operations. The system can permit collection and review of data and information generated from a plurality of clinical trial sites pursuant to centralized clinical trial quality control procedures and steps of applied algorithm(s) integrated therein, which can accelerate the clinical trial workflow and make the clinical trial results more reliable.

Clinical trial workflow can be managed by the method and system of the present invention in at least Pre Trial or During Trial phases. In Pre Trial phase, at least one representative of a system medical team and a decision maker or decision makers (e.g., a principal investigator), for example, for the respective clinical trial, can confer to establish and agree upon on a clinical trial protocol for the clinical trial. The representative of the system medical team can provide feedback to properly set the workflow of specific protocols. When needed and/or requested, the indicated representative can suggest modifications to the clinical trial protocol. The indicated representative can gather the necessary details needed to configure a server, e.g., the defined tables. The indicated representative can interact with a network software team, for example, to develop such configurations. The indicated system medical team, and the indicated system software team, can be affiliated with an entity or organization that develops and manages the system, and can customize the system to handle the workflows of different clinical trials. The indicated representative and the principal investigator, and/or any contract research organization involved, may contractually formalize their relationship for the setting up and management of the clinical trial. When required as part of the protocol, a central core laboratory can be used to start the qualification procedures required for the sites to be included in the clinical trial. The central core laboratory, for example, can communicate with a contract research organization (CRO) regarding the centers' qualification process. The system software team can customize the default interfaces at the server as required by the clinical trial protocol, e.g., upload form; review form; in-between entities interactions; notifications, and the like. When a client requires additional custom modules, the core laboratory can start building them and can internally test the customized product. After the internal tests are passed, external tests can be performed by the client. After both internal and external tests are passed, the platform can be deployed and full access to it can be granted to the client(s). In an example, the core laboratory and/or a designated clinical trial contact person insert(s) the users into the system, e.g., submitters, reviewers, site medical doctors, and so forth. When required as part of a clinical trial protocol, the core laboratory can start and conduct a reviewer-training program.

In the During Trial phase of the clinical trial, the contract research organization (CRO) can start populating (in a manual and/or automatic manner) the subject lists in the system. As indicated, for real time auditing, when an imaging study (IS) is uploaded to the system, the system can be configured to perform several automated quality procedures, e.g., digital communication in medicine (DICOM) compliance check; file anonymity (HIPAA) check; protocol compliance check (e.g., new patent to be submitted), time frame submission compliance, and the like. When the IS files present problems beyond automatic recovery, the following levels of interactivity can occur. When there are missing data, the system can automatically prompt the submitter to provide them. If the added data do not make the IS compliant, the system can be configured to reject it. When the protocol has strict compliance rules and the system determines that the IS is beyond recovery, the IS can be rejected. When the protocol has less stringent compliance rules and the system determines that the IS cannot be automatically recovered, it can keep it and notify the core laboratory. The system can be configured to automatically monitor the IS submission process and the IS presenting compliance errors can be logged for review and reports thereon. When required, the system can send automated notifications when compliance errors are discovered, and the level of compliance errors and notifications are customizable. Upon a successful IS submission, clinical trial-dependent notifications can be sent to core laboratory users; reviewers; contract research organization (CRO) users; principal investigator (PI), or other users of the system. When required by the trial protocol, the core laboratory can perform a manual IS revision, wherein the IS becomes downloadable only after the said revision is passed. Notifications can be sent to the reviewers of a compliant submitted imaging study by email and/or SMS informing them about the availability of a new IS for the said clinical trial. Reviewers can be involved in several clinical trials concurrently, so the notifications can include a clinical trial identifier. Each reviewer can proceed to login in the system and download the respective IS files on her/his computer. After download, the reviewer reviews the IS using her/his software of choice. After reviewing the case, the reviewer accesses the system and inserts her/his report in the review form. When submitting a report web form (RWF), the reviewer takes responsibility for its content, which is then handled by the server. The reports of the reviewers are evaluated for concordance. When a consensus criterion or criteria established by the clinical trial protocol is reached, the system sends automated notifications (email and/or SMS) to site medical doctor(s), principal investigator, contract research organization, or others. Real time auditing during the clinical trial can be provided wherein the system performs several automated review checks on ISs, which can include time-frame reviewing check (when required by the protocol), and review consensus check. When required, the system can send appropriate automated notifications. These and other aspects of the system of the present invention are further illustrated in the following figures and discussions.

Among additional benefits of the method and system of the present application, there is verifying compliance of images performed by scanners with standards required, and tested upfront through calibration of the devices through phantoms. When applied to an imaging-based clinical trial (iCLT), the enlisting of recruiting clinical trial sites and their qualification can be implemented by a core laboratory with a Web-based procedure that makes use of imaging scanner calibration data, for example, such as generated by an imaging phantom designed in order to simplify the procedure from the point of view of clinical trial sites and a test subject. As a consequence, imaging data can be centrally analyzed. The level of imaging quality control can be substantially increased, non-compliance can be immediately identified and sites can be requested to take action according to the non-compliance rules specified in the clinical trial protocol. In an example, only when the calibration procedure is successfully completed the sites are allowed to start the subject recruitment. As an additional benefit, there is checking of the quality of images and their cross compatibility from different recruiting centers and calibration of devices performing those images.

With a Web-based approach of the present invention, no specific computing hardware or software is required at the sites to use the system, so the number of participating sites can be substantially increased without any overhead in the clinical trial configuration. A larger number of sites can enroll the required number of subjects in a shorter time and therefore can turn into a shorter time interval required to meet the statistical goal of the clinical trial, as the two quantities typically are inversely proportional. Further, “real-time” auditing on sites can be applied to the workflow. Since the imaging studies, for example, can be collected and stored on a common server and are available for further analysis, a structured and systematic procedure to check the imaging study compliance to the clinical trial protocol has been implemented. The outcome of this procedure is a compliance level for each analysed imaging study. The average site non-compliance can be computed at any time and a non-compliant imaging study can be labelled and the corresponding recruiting site and the principal investigator can be notified. If required by the clinical trial protocol (CTP), non-compliant imaging studies can be rejected. Depending on the actual imaging study compliance rate, the expected time to reach the endpoint of the clinical trial can be computed and its possible delays caused by non-compliant sites can be estimated. From a quality control standpoint, since repeating a non-compliant imaging study is usually not possible, it is very important to quickly spot critical non-compliances, so as to correct them and minimize their impact on the clinical trial duration and outcome. Further, “real-time” imaging study validation can depend on the clinical trial protocol requirements and endpoints, so the imaging studies can be validated with custom algorithms. The data homogeneity and interoperability, for any imaging modality, can be granted by the “real-time” imaging study validation. For positron emission tomography (PET) imaging studies (ISs), for example, the availability of the information required to compute the standardized uptake value (SUV) is verified, as well as its consistency. In particular, correction for systematic errors caused by the data encoding provided by some scanners can be implemented. The error on SUV can be computed by taking into account all the independent variables that contribute to the final uncertainty. PET ISs can be then assigned an index that defines their acceptability for quantitative analysis. Further, “real-time” IS automated analysis: since the whole clinical trial imaging dataset is collected on the indicated server, it is possible to implement standard and/or custom algorithms that analyze it. Standard algorithms can be implemented and include the evaluation of indices (e.g., specificity, specificity, data dispersion, outliers identification) and other information useful for the clinical trial endpoints and for further optimization. Custom algorithms include any specific procedure that is tailored on a clinical trial protocol, be it the evaluation of indices or the IS analysis with dedicated algorithms, including computer assisted detection (CAD). The implementation of custom algorithms, made possible by the workflow control functionality of the indicated management system, can be done on demand. In addition, “real-time” auditing on reviewers is provided. The availability of single reports by each member of a reviewer panel, for example, uploaded on the indicated server, allows a continuous monitoring of the agreement level for the review panel, who may be separately located worldwide, and for any pair of reviewers. Unexpected disagreements can be notified to the principal investigator and, depending on the clinical trial endpoints and on the predefined rules for non-compliance correction defined in the clinical trial protocol, action can be taken to inform the reviewers and/or to change the reviewer panel composition. Core laboratory overview and coordination can be provided by the system. The core laboratory can be responsible for collecting and analyzing all the information generated by the above-described functionality. Its role in information handling can be used to optimize the response to any anomaly or violation in clinical trial operations with respect to the critical trial protocol. The core laboratory can increase the effectiveness of all the procedure for real-time monitoring of the clinical trial key indicators and the possible non-compliances. The core laboratory can then trigger auditing sessions on non-compliant sites or reviewers, according to predefined rules for site non-compliance correction agreed by the CRO and the PI. The information gathered during the whole procedure can be made available to the clinical trial principal investigator and can be used to maximize the clinical trial overall effectiveness. Periodical reports can be generated by the system and sent to the clinical trial principal investigator with the requested information (e.g.: number of enrolled subjects per site, average subject clinical trial rate, ratio of observed/expected patient enrolment, ratio of observed/expected patients undergoing a definite imaging study, site compliance rates with imaging clinical trial protocol, reviewer panel concordance, rate of outliers in the reports, average report confidence level, or other quality control information. In addition, all the interventions on patient data made in the indicated method for the clinical trial workflow implementation and management can be logged and the logs can be available for inspection. The indicated method for the clinical trial workflow implementation and the real-time auditing can be relevant for any imaging modality. Some parts, related to the site qualification process, can specifically cover PET-related functionality.

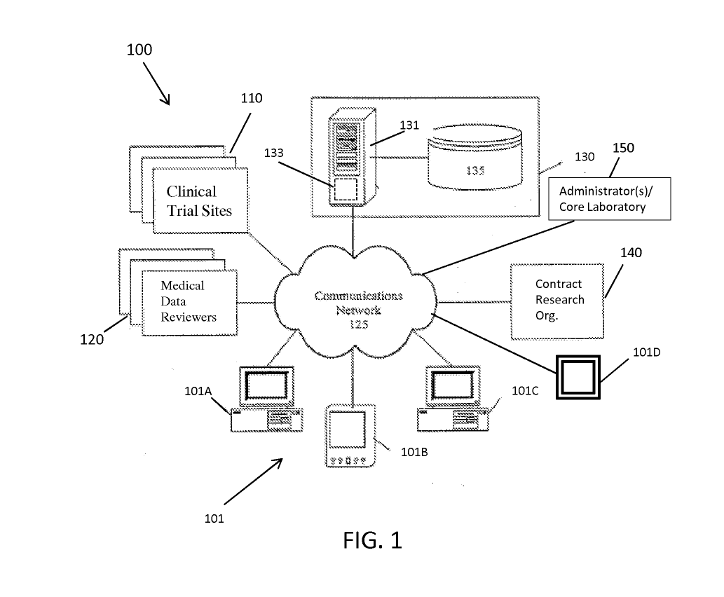

FIG. 1 is a schematic diagram illustrating a system for managing aspects of a clinical trial over a communications network in accordance with an example of the present invention. As shown, the system 100 can include one or more clinical test sites 110, one or more reviewers 120 of diagnosis data generated at the sites 110, a web-based clinical study computer system 130, a contract research organization 140, and an administrator (or administrators) 150. The computer system 130 can include at web server computer 131, at least one processor 133, and data store or memory 135. Devices 101 (e.g., 101A, 101B, 101C, 101D) are devices equipped with an Internet browser, which clinical trial investigators, administrators, sponsors, submitters, reviewers, and/or other authorized participants can use to communicate with the computer system 130 via the communications network 125 for data exchange.

The number of devices 101 shown in FIG. 1 is illustrative and is not limited. These devices can be deployed on-site or off-site from any of the indicated locations, such as test sites 110, reviewer locations 120, contract research organization location 140, system administrator/core laboratory location 150, or other locations related to the workflow and management of the clinical trial. The devices 101 can be mobile handheld or laptop devices (e.g., smartphone, PDA, laptop computer, tablet computer) or can be more stationary location devices (e.g., desktop computer, etc.). The aforementioned devices and system can serve as a communication “node” that can be communicatively linked to the computer system 130 via the communications network 125. That is, each node can include an information processing system having suitable networking software and/or hardware, whether wired or wireless, for communicating over the communications network 125 with the computer system 130. The communications network 125 can be the Internet, a mobile phone communications network, satellite communications network, Public Switched Telephone Network, cable television line, or other communication network. The communications network can be a network that operates on Internet protocol (IP). In an example, the communications network 125 is the Internet and the access devices 101 have a web browser. Additional software is not required on the devices 101, other than image review software in the case of the reviewers, depending on the type of diagnosis data that needs their review. The devices 101 can make URL (Universal Resource Locator) connections to the web server 131.

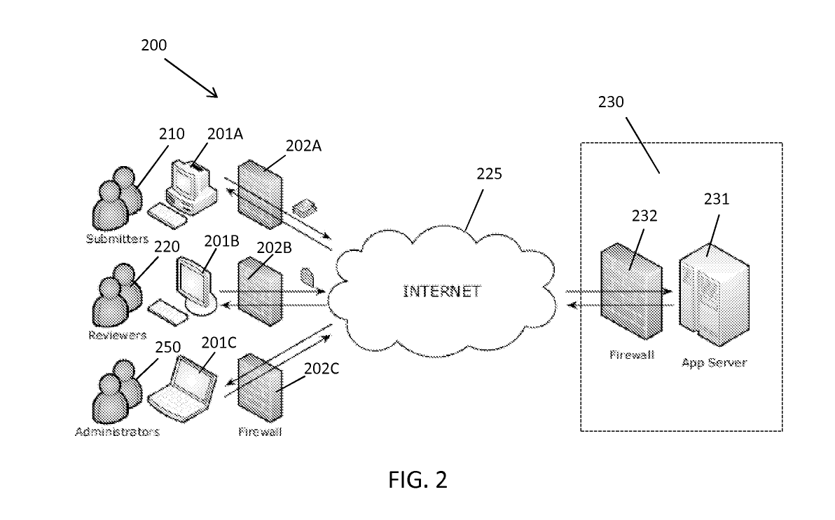

As shown in FIG. 2, the system 200, which is an example of the system of FIG. 1, can be a web-based communications network. System 200 can provide secure connections to the server 231 of computer system 230 by including a firewall 232 to guard computer resources of the system 230 including the server 231, and firewalls 202A, 202B, 202C to guard computer resources 201A, 201B, 201C used by clinical trial submitters 210, reviewers 220, administrators 250, for example, who can access the system 230 via the Internet 225 as the communications network. Connections to the server can be made, for example, through a pre-determined HTTP (Hypertext Transfer Protocol) port in the firewall 232. Data can be allowed to flow in both directions between the users and the server 231, such as subject to firewall rules established for the firewalls by administrators and any other access restrictions to the server 231 that have been applied to the users.

While shown as single objects, it should be appreciated that the server 131 (231) and the data store 135 can be implemented as one or more distributed storage devices and/or computer systems, each being communicatively linked with one another as well as the communications network 125 (225), and each being part of the online clinical study system 130 (230). In any case, the server 131 (231) can execute one or more applications, programs, and/or scripts for coordinating aspects of a clinical study as exemplified herein in an online fashion. A plurality of application programs or as a single, more complex application program, for example, can be executed within a Web site accessible on the server using the processor 133. Data required by the server 131 (231) can be stored within the data store 135. The server 131 (231) can control aspects of a clinical study including subject enrollment and randomization, auditing compliance with clinical trial protocols, performing adverse event monitoring, processing reviewer reports for concordance, or other functions, or any combinations thereof. The data store 135 can include data for subjects participating in the clinical study, clinical trial protocol and compliance data, clinical research data for each subject collected during the clinical study, information pertaining to the participating sites, reviewer reports and performance, and the like. For example, reviewer report forms can be stored online and, thus, be available for viewing and/or printing by users granted access to that data. With respect to the fields of the reviewer report form, it can be in electronic format such as a Web page. Training materials also can be provided within the data store 135. The training materials, or content, can include imaging data or other diagnosis data from previous trials, audio, text, graphics, and/or video which can be accessed by clinical trial participants for training at that participant's time of choosing or prompting by the system. Results of the training can be saved and documented in the data store 135.

As noted, the system 130 (230) can be implemented as a Web site, for example, wherein various participating entities of a clinical trial, reviewers, contract research organization personnel, principal investigator, administrators, or other persons involved in management or workflow of the trial, can access the centralized Web site via appropriate interfaces, or Web pages. An investigator, administrator, and/or sponsor can define a particular workflow. A user, for example a sponsor, administrator or an investigator, is logged onto the system, and the system presents the workflows for which the user has been authorized. The system can receive a user input selecting a particular workflow for which the user has been authorized. It should be appreciated that if the user accessing the reporting workflow is a principal investigator or administrator, the principal investigator or administrator may access functions across all investigators and/or participating sites. If the user is an investigator at a particular site, however, the user can be limited to viewing information relating to that site. For example, a unified interface can be provided wherein an accessing trial participant, upon logon, provides an identifier which associates the participant with a particular class of user having a set of access rights governing that participant's interaction with the system 130 (230). The user can be authenticated, for example, using a username and password. After login, the participant can be shown one or more other pages and/or interfaces to the functions which that participant may access. The system 130 (230) can include one or more electronic forms having multiple choice click-boxes, fillable data fields, or combinations thereof, which can be accessed by participating sites and electronic forms which can be accessed by reviewers. Electronic source document verification for use within a clinical trial can be provided. Where a user has already logged onto the clinical study system, the user, in this case a physician or other medical researcher, can enter subject data into an electronic form provided by the clinical study system. The subject data can be checked for formatting errors and time frame-for-reporting non-compliance. The clinical study system can process the data and send a summary of the data to be displayed upon the user's screen, and indicated non-complying answers in fields in the form. The subject data can be displayed as part of a Web page or the like. The verified clinical research data can be stored in the centralized database of the clinical study system, and reviewers can be notified of imaging study data available for review and submission of their reports thereon.

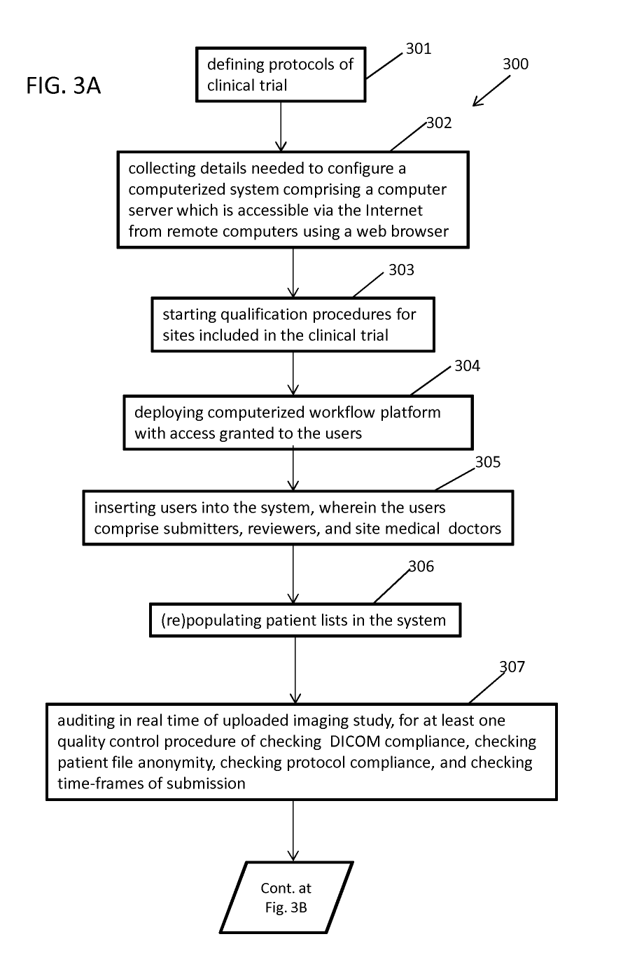

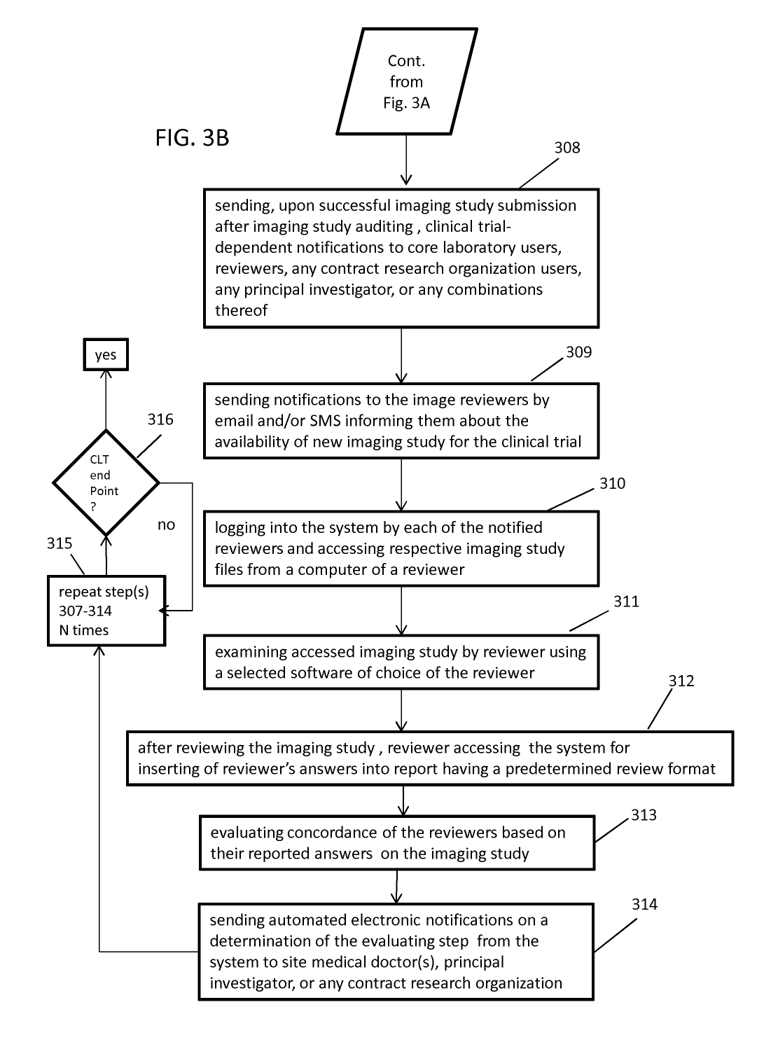

FIG. 3 shows a process flow diagram of a method according to an example of the present application. The process 300 is illustrated with steps 301-316, which steps are not all necessarily required or in the specific order shown, and additional steps may be included in the workflow such as described herein. This illustration refers to the workflow as applied to an imaging based clinical trial wherein medical data that comprises imaging study data is collected from patients and distributed to reviewers for examination and review and diagnosis exchange. The imaging data can comprise, for example, a positron emission tomography (PET) image, a magnetic resonance image (MRI), a computer axial tomography scan (CAT Scan) image, or a sonogram. The workflow of the present invention is not limited to application to imaging based trials. Other modalities can be handled in the workflow of the present invention. In general, any DICOM supported modality, but also images that are not DICOM compliant (i.e., pathology images) can be handled, although in that case no DICOM compliance checks indicated herein are performed.

The process 300 can begin with the contacting of a decision maker(s) for a clinical trial, agreeing upon a clinical trial plan, and setting protocols of clinical trial plan (301) with appropriate and coherent use of imaging studies, including the definition of the time points of imaging studies, in order to meet the clinical trial endpoints. Details can be collected that are needed to configure a computerized system comprising a computer server which is accessible via the Internet from remote computers using a web browser (302). Qualification procedures for sites to be allowed to join the clinical trial can then be started (303). A computerized workflow platform can be deployed with access granted to the client (304). Users are inserted into or identified in the system, wherein the users comprise submitters, reviewers, and site medical doctors, or other users (305). Patient or subject lists can be populated in the system at this time (306). During an ongoing trial, these lists can be updated and/or enlarged. As indicated, all the interventions on patient data can be logged and the logs can be available for inspection. Auditing in real time can be performed when an imaging study is uploaded to the system (307). The auditing can comprise at least one quality control procedure of checking digital communication in medicine compliance, checking patient file anonymity, checking protocol compliance, checking time-frames of submission of data from collection, and/or other procedures. Upon determining that a compliant imaging study has been submitted, clinical trial-dependent notifications can be electronically sent to core laboratory users, reviewers, any contract research organization users, any principal investigator, or any combinations thereof (308). Notifications are also electronically sent to the image reviewers, such as by email and/or SMS, informing them about the availability of a new imaging study for the clinical trial which need their review and diagnosis feedback within a prescribed time period (309). The notified reviewers then can log into the system to access the respective imaging study file from a computer of a reviewer (310). The reviewer then can examine the imaging study using a selected software of choice of the reviewer (311). After examining the imaging study, the reviewer can access the system to insert the reviewer's answers into a report having a predetermined review format or template (312). Concordance amongst the reviewers can be evaluated and determined based on their answers inputted for a common imaging study (313). Automated electronic notifications can be electronically sent upon the indicated concordance determination on the reports of the reviewers from the system to site medical doctor(s), principal investigator, or any contract research organization (314). Steps 307 to 314, for example, can be repeated one or more times (N times) during the clinical trial, such as when imaging protocol auditing and reviewer concordance and quality control are desired or scheduled as new imaging studies are collected at clinical sites that need review (315). This workflow can be continued until a clinical endpoint is reached (316).

The method and system of the present invention can be described in more detail under Parts I, II, III and IV as follows. Part I describes information about the steps of data collection, such clinical data and imaging data. Part II describes information about the peripheral clinical trial centers, the collection of samples, and the like. Part III includes a description of the trial, its operating functions, the configuration of the web server at the analysis center, and the like. Part IV describes information about the training/education of doctors charged with analyzing the collected data.

In using the system for defining the protocol workflow, qualification forms, reporting forms, and the like for managing the CLT, Tables can be generated by the system that present data fields for data entry by the user, yes/no click boxes or other multiple choice click boxes, and the like for the user to make a choice between defined options that present by the template forms displayed on the user's interface display.

### Part I

For setting clinical trial protocol assessment, the first stage of the system configuration procedure can comprise in evaluating the appropriateness and the coherence of the CLT endpoints. Moreover, information on the number and the timeline of the Imaging Studies (ISs) foreseen by the CTP and on the need of a Review Panel (RP) for one or more ISs is obtained. If required, the CTP can be integrated and/or modified according to this information. The evaluation procedure might require iterations with the Principal Investigator (PI), the Contract Research Organization (CRO) and the Sponsor. The final version of the CTP can be approved by the PI, the CRO and the DMT.

Some exemplary specifications to set up an imaging-based Clinical Trial (iCLT) are illustrated in the following sections. Randomized CLTs (RCTs) are the gold standard for shaping clinical practice by providing definitive evaluation of treatment efficacy. A therapeutic intervention or a single drug could be the object of a randomized CLT. RCTs are often used to test the efficacy of various types of intervention within a patient population. The key distinguishing feature of a RCT is that study Subjects, after assessment of eligibility and recruitment, are randomly allocated to receive one or another of the alternative treatments under study before the intervention begins. The details of random allocation in real CLTs are complex, although conceptually the process is like tossing a coin. After randomization, the two (or more) groups of Subjects are followed in exactly the same way, the only differences between the care they receive (for example, in terms of procedures, tests, outpatient visits, follow-up calls etc.) being those intrinsic to the treatments being compared. A RCT protocol can usually specify a primary endpoint as an observable that can define the success/failure of the action/therapy being trialed. A RCT protocol might also define one or more secondary endpoints, related or not to the primary endpoint, that might not be met without compromising the RCT success. In oncology, Overall Survival is the most objective endpoint to measure the Subject benefit. In some settings, however, Progression or Failure Free Survival (PFS-FFS) is preferable. In CLTs, the primary endpoint is usually a clinical measure such as Overall Survival or PFS, while the results related to the Imaging Techniques are usually secondary endpoints.

From a general point of view, the system can be a platform that can implement imaging and diagnosis exchange in iCLTs. Imaging handling in CLTs could be done outside specific requirements and is not subject (yet) to the control of international regulatory authority, provided that images are not manipulated. Sensible data (Imaging included) from Subjects enrolled in a CLT is collected, transferred or analyzed under the responsibility of the Principal Investigator (PI). The latter, in turn, delegates a CRO to handle these data. In case of iCLTs, the PI delegates an imaging CRO (iCRO). The iCRO role in an iCLT is, by international convention, the following: To control the input into study design: to check that information to be obtained from ISs in a CLT is coherent with the expected Sensitivity, Specificity, Positive Predictive Value (PPV) and Negative Predictive Value (NPV) of the same IS in the same clinical context. Training and qualifying Sites: to check that a specific QA/QC program has been implemented and planned before CLT onset, for all IS generating Sites (IGS) participating to a CLT. Ensuring protocols (imaging acquisition, reconstruction and interpretation) are harmonized: to check that ISs have been generated in accordance with an internationally shared protocol for Subject scanning and image reconstruction; to check that protocols for IS generation (imaging acquisition, reconstruction and interpretation) are harmonized among IGS; to check that the interpretation rules of an IS are appropriate to the CLT endpoint; to check that the skill of image reviewers is appropriate for the specific task they are asked to perform. Central IS QC and analysis: to check that in case of imaging centralization a proper imaging quality check has been successfully completed before ISs are distributed to reviewers. The most common problems encountered in an iCLT that is properly monitored by an iCRO are: Protocol adherence: IGS can be monitored in order to check that the IS execution complies with the CTP workflow and that actions triggered by the IS results are appropriately taken. This can be done by several means: System® per se is able to perform a sort of IGS surveillance by an automatic check of the essential parameters planned by the imaging acquisition protocol adopted by the CLT. A full imaging auditing can also be planned with inspections by the DMT, on behalf of the PI or CRO, to IGS that can be performed either randomly or “on demand”. In the latter case a set of monitored parameters can be defined a priori and audit can depend on the number of detected CTP violations. Reversion to clinical practice. It is not uncommon that specific CTP requirements are overlooked by IGS and that a reversion to clinical practice overtakes the specific requirements for imaging generation. The risks of these deviations are prevented by system dataflow control in most cases; in other cases only a program for regular (or random) auditing inspections to IGS could prevent this phenomenon. Local “improvements”: At the opposite end of the spectrum it sometimes (often) happens that an IGS adopts minor or major deviations from CTP requirements during several steps of the imaging generation process. These violations are often deemed as “improvement”, but they are indeed CTP violations. Again, an auditing program can prevent this kind of CTP violations. For FDG-PET, FDG uptake time after injection. For iCLTs in which a PET scan is among the selected ISs, a number of parameters affecting quantitative and qualitative PET scan assessment can be checked and a protocol to monitor these parameters can be set-up. If system is used, a number of controls on IS acquisition conditions are automatically performed. Sending IS data to the iCRO: this is a sensitive process. ISs are handled in a CLT exactly as a normal clinical or laboratory datum: transferring ISs from an IGS to an iCRO and vice-versa is subject to the same rules as for clinical handling by a traditional CRO. Subject data anonymization and utilization only in the definite context of the CLT and with a specific authorization by the Subject are required. The system can be purposely conceived to meet these requirements.

When the DMT is asked to consider the use of system in an iCLT all the above issues (iCRO role and problems in iCLTs) can be considered and a checklist dealing with all the information related to these issues can be filled in a stepwise fashion.

The rapid technological evolution of IS execution and interpretation as well as the improving performance of imaging generating machines and the production of new tracers has revolutionized the role of imaging, and in particular of Functional Imaging (FI). PET-CT proved an essential tool in oncology for tumor staging and restaging at the end of treatment. In the last decade several publications focused on the ability of PET-CT to predict treatment failure and on its role in guiding the treatment intensity in Subjects with different risk level of treatment failure.

As a matter of fact, a new generation of CLTs based on the central role of FI has been spurred by these preliminary observations. However, the different accuracy and predictive value of an IS as well as the complexity of its interpretation prompted researchers to set up a central RP composed by expert clinicians in the field of imaging to homogeneously review the ISs for all the Subjects enrolled in a CLT.

With respect to clinical endpoints, a clinical endpoint is a result that can be achieved with a determinate action/therapy in the context of a CLT. The results of a CLT generally indicate the measured efficacy of a drug or of an intervention obtained in a sample of Subjects with a predefined size. In CLTs imaging is often an essential tool to verify whether the results met the endpoint. As an example, the FI ability to identify subjects with a poor prognosis turned out very useful to select aggressive treatment only to patients that really needed it. In other words, FI has become part of a first-line treatment in oncology to maximize treatment efficacy in poor-risk Subjects and to minimize the toxic effects of therapy in Subjects with an expected favorable outcome. Several aspects of the use of ISs in a CLT are still preliminary and await confirmation. Therefore, some statistical endpoints such as overall accuracy and predictive values of a determinate IS, as well as the concordance rate among reviewers, can become a secondary endpoint in a CLT.

With respect to use of imaging in CLT, in oncology daily practice, the volumetric assessment of tumor bulk, e.g., metabolic tumor volume (MTV), by means of FI provisionally may be useful as a tool in steps of the clinical management of the neoplastic disorders, from diagnosis to follow-up. The different ISs and the relative performances in tumor detection, prognostication and treatment response assessment are currently exploited in CLTs. Therefore, in a given CTP, ISs can be scheduled at different steps of protocol workflow, depending on the CLT endpoints.

Different IS techniques are used as “screening test” in CLTs. Low-voltage CT has been recently demonstrated to be an efficacious screening test in a large cohort of person screened for lung cancer. The test, performed in large scale to detect the presence of lung nodules, possibly harboring lung cancer, allowed physicians to diagnose the tumor much earlier than in the standard reference population. As a result, a significant survival gain over the control population was obtained in the screened population.

There are a number of clinical situations in which an IS is an essential part of the diagnosis. This is the case of most neoplastic disorders but it is not uncommon that an IS is used for the diagnosis of infectious/invasive diseases such as Invasive Aspergillosis (IA) of the lung. In this case the IS is a Contrast-Enhanced Computed Tomography (CECT) scan and some peculiar signs such as the “halo sign” of the “air-crescent” are mandatory for the diagnosis. In CLTs aimed at formulating a clinical diagnosis of IA as early as possible, the CECT central review is likely to be essential. Histological confirmation is one of the essential requisites to enroll a Subject in a CLT. Presently, histological diagnosis is provided by the different institutions where the Subject is diagnosed and enrolled in the CLT; a central review of the histological images and diagnoses could be performed in the next future thanks to the technological progress in imaging distribution and image information pick-up. In several CLTs a specific IS is used to assess the response to the therapy at the end of or early during treatment. In this situation it is often requested that the same IS be done at baseline as “reference” test. In this perspective the presence/absence of a definite IS at baseline can be the reason of Subject inclusion/exclusion from a CLT.

Tumor burden assessment is an essential task in Oncology, in order to define the Subject prognosis and therapeutic strategy at baseline. Most chemotherapy and radiotherapy regimens are tailored to subject stage at baseline. Several ISs have been proposed for staging in oncology: the choice of the best method depends on the sensitivity and specificity of a particular IS but FI (PET scan) has proven to be superior to standard radiological tools (CT scan). Moreover, in recent years, prognostic categories have been proposed based on specific imaging information obtained during staging at baseline. During the last decade a new category of prognostic factors has emerged as an effective tool for treatment tailoring on a single-Subject basis: the early tumor chemo-sensitivity assessment during treatment. The method has been implemented with different techniques in Onco-Hematology with the aim of detecting Minimal Residual Disease (MRD) as early as after 1 or 2 cycles of chemotherapy: by cytofluorimetric assay in acute leukemia, by molecular biology in chronic leukemia and lymphoma and by FI (PET) in lymphoma. Several CLTs aimed at guiding treatment intensity in lymphoma, based on very early chemo-sensitivity assessment during treatment with PET scan (Interim-PET), are ongoing. The issue of treatment modulation during first-line treatment in Oncology in the context of a CLT prompted researchers to set-up reliable tools to offer the Subjects the same (and best) interpretation criteria for the IS assessment. This goal can be achieved by implementing (a) an expert RP for central IS reviewing with shared and robust reporting criteria; (b) an imaging exchange and distribution from participating IGSs to the RP and vice-versa, so as to timely provide clinicians with a reliable IS interpretation, avoid time delays and preserve the treatment intensity. End-therapy tumor response assessment has been one of the first applications of Imaging in Oncology. Several Imaging Modalities (IMs) have been proposed to evaluate the treatment response, but FI (PET and Diffusion-Weighted Magnetic Resonance: DWMR) turned out as the most accurate method. New criteria for lymphoma treatment response have been proposed incorporating PET among the required ISs. End-treatment tumor response evaluation by functional imaging has emerged as the principal prognostic factor in predicting PFS of different hematological neoplasms (lymphoma, multiple myeloma). Several CLTs are now underway evaluating the role of PET in abbreviating or omitting part of the standard treatment. As an example, in some lymphoma subset currently treated with combination of chemotherapy and radiotherapy, end-chemotherapy PET scan is currently being tested as the method for deciding whether radiotherapy should be added to chemotherapy or not. Again, due to the lack of general consensus for end-therapy functional imaging assessment, a procedure for central imaging review should be implemented in CLTs with end-treatment tumor response assessment as endpoint.

The role of Imaging in subject follow-up is still an unsettled issue: it probably is the only aspect of neoplasm management in which the role of imaging is still debated. In fact, the value of a surveillance imaging test in follow-up of Patients in Complete Remission (CR) after first-line treatment depends on the intrinsic propensity of a determinate neoplasm to relapse and on the sensitivity and specificity of the IS test to detect an impending relapse in an asymptomatic Subject. Therefore, the role of IS for surveillance of Patients in CR after 1-st line treatment is still unsettled. The original single modality treatment with extended radiation fields has been replaced by conformal fields designed for combined modality (chemotherapy and radiotherapy) treatment. The use of combined MRI, PET, US and CT is a common approach in most of radiotherapy departments for Biological Tumor Volume (BTV), Gross Tumor Volume (GTV) and Clinical Tumor Volume (CTV) identification. Moreover imaging is currently being extensively used also in radiotherapy treatment planning, with bi-dimensional (EPID Electronic Portal Images Devices) and three-dimensional (CT) imaging. Imaging can also be used to adapt treatment during therapy. With Image Guided Adapted Radiation Therapy (IGART) it is possible to identify the tumor shrinkage during therapy and hence adapt the treatment planning accordingly, sparing unnecessary dose to the healthy tissues.

The system, as a general tool for ISs, can also be used to exchange Radiotherapy Images for Radiotherapy planning as defined in the DICOM-RT standard. It is hence possible to conceive CLTs that use radiotherapy in their clinical workflow in the same way as done for ISs. The system can encourage the use of imaging biomarkers in all the CLT it manages in at least three different ways: 1) by promoting standardization of IS protocol; 2) by guaranteeing the reliability of the results of IS data used in CLT; 3) by promoting quantitative analysis in every IS.

IS plays a central role in any iCLT. Therefore it is essential that any IS is properly located in the CTP workflow and its results are coherent with the CLT endpoints. The IS, as any test, can meet two fundamental requirements: accuracy and precision. The system can ensure that both accuracy and precision are properly addressed in the CLT. Accuracy of a diagnostic test is its correspondence with the true value. Accuracy is maximized by calibrating equipment with reference and by participation in external quality control programs. Precision is a measure of tests reproducibility when repeated on the same sample. An imprecise test is one that yield widely varying results on repeated measurement. Diagnostic accuracy is usually characterised by the sensitivity and specificity of a test, and these indices are most commonly presented when evaluations of diagnostic tests are reported. It is important to emphasise that, as in other empirical studies, specific values of diagnostic accuracy are merely estimates. Therefore, when evaluations of diagnostic accuracy are reported the precision of the sensitivity and specificity estimates or likelihood ratios can be stated. If sensitivity and specificity estimates are reported without a measure of precision, clinicians cannot know the range within which the true values of the indices are likely to lie.

With respect to imaging accuracy, several metrics that correlate the test result to the Subject clinical outcome are used to measure the accuracy of a test: sensitivity and specificity, PPV and NPV. The parameters can be defined by the following formulas as a function of the number of “True Positive” (TP), “True Negative” (TN), “False Positive” (FP) and “False Negative” (FN) cases: Sensitivity=TP/(TP+FN); Specificity=TN/(TN+FP); PPV=TP/(TP+FP); NPV=TN/(TN+FN). An IS in a CLT can be chosen for one or all of the above-mentioned properties. For example, a high PPV and Specificity and a high Sensitivity and NPV can be aimed at intensification and de-intensification, respectively, as a trade-off for therapy to avoid over- and under-treatment.

Precision in an IS means that IS is highly reproducible, meaning that the interpretation criteria are clearly defined in the CLT and that the process of Imaging Review is strictly controlled to ensure adequate inter-observer agreement. There are several types of Imaging Review: blinded, un-blinded, independent or consensus, prospective or retrospective, local or central. However one of the most widely used methods is the Blinded Independent Central Review (BICR). In this kind of review a RP composed by several experts is in charge for IS Review and all the panel members report in an independent way. ISs can be distributed to reviewers, an electronic reporting form can be implemented and the result of central reviewing can be timely communicated to clinical Sites participating to the CLT. Moreover, binary (among paired reviewers) and overall (among all reviewers) concordance rates can be calculated and the results monitored throughout the CLT progress from the first up to the last enrolled Subject. The results of the review performance assessment can be regularly transmitted to the PI. All these actions are readily performed by the system. Moreover, a review confidence level can be taken into account when interpreting an IS. That means that a result can be associated to a scale of confidence that is part of the review form. The efficacy of the results can then be estimated more precisely with a Receiver Operator Characteristic (ROC) analysis. To improve the completeness of IS reporting, to allow readers to assess the potential for bias in the study and to make IS results comparable to international standard parameters; all the statistics can fulfill the Standards for Reporting of Diagnostic Accuracy (STARD) requirements [ARSDA]. A checklist can be used by the system in a point-by-point fashion. The specific requirements for the imaging generation process depend on the way IS can be interpreted. In morphological images like Ultra-Sonography (US) and Computed Tomography (CT), image interpretation is based on the anatomy of the organs contained in the radiological slice and on their reciprocal topographic relationship. The situation is completely different in functional images such as Positron Emission Tomography (PET) or Magnetic Resonance (MR) scans, where the metabolic activity of an organ is matched with its anatomical appearance. Metabolic activity can be assessed in different ways: in PET scan reporting, for instance, in certain circumstances a qualitative evaluation by visual assessment is preferred, while in other circumstances a quantitative approach by Standardized Uptake Value (SUV) is more appropriate. With MR scans, different approaches are used in imaging elaboration according to its acquisition sequence (T1, T2 or proton density).

Each IS planned in the CTP is an event. An event is in turn classified as Notification Trigger Event (NTE) or Notification non-Trigger Event (NnTE). In the former an event defines the logical conditions that, during the CTP, generates the request for one or more notifications to one or more involved players. All the information on the CTP workflow, on the actions triggered by IS results and the relative responsibility of CRO or iCRO can be gathered to properly plan the resource allocation as a function of time.

Depending on the complexity of the ISs scheduled in the CTP, a thorough program of Quality Assurance (QA) and Quality Control (QC) can be implemented and shared among the participating IGSs. QA and QC operations can start before CLT onset and this pre-analytical set of procedures can be documented for every single IGS participating to the CLT. Detailed description of the implemented procedure to grant QA and QC, a feature of system, is included herein.

Statistical requirements are a very important constraint in designing any iCLT. When a prefixed endpoint is set during a CLT planning and is important to monitor the adherence of the IS results to a prefixed value in order to reach this endpoint, an automatic tool allowing the PI and/or the CRO to control the data flow related to IS results in real time is essential. Moreover, if a minimum concordance rate among reviewers asked to interpret a definite IS is set a priori in the CTP and it is part of one of the CLT endpoints, it is essential that the PI and/or the CRO could rely on a tool able to elaborate a real time statistical analysis to timely and periodically check the concordance rate among reviewers. The system provides the corresponding functionality.

As indicated, Tables can be used to ask for the general and clinical information required to setup the system by configuring, for example, the CLT customized WEB-site that implements the workflow foreseen by the CTP and the Core Laboratory procedures required for the pre-trial QC and the QA actions during the CLT operations. In addition, the CLT Synopsys and the CTP Workflow diagram provided by the PI can be made available on the CLT WEB-site. This general information, which identifies a specific configuration for a defined CLT, can include: CLT Name: it is the CLT Name as officially recorded; CLT Short name: it is a possible alias for the CLT Name used by the researchers involved in the CLT; CLT NCT Identifier: it is the official identifier as assigned when registering the CLT on the ClinicalTrials.gov registry; CLT Title: it is the official title as recorded on the ClinicalTrials.gov registry; Expected Recruiting Starting Date: the expected date for the starting of the Subject recruitment, and Clinical Phase information.

During a new drug development two phases can be distinguished: a preclinical phase (in animal) and a clinical phase (in humans), and the clinical phase is conducted with five-phases CLTs. Each phase of the drug approval process is treated as a separate CLT. A drug-development process can normally proceed through all four phases over many years. If the drug successfully passes through Phases 0, 1, 2, 3, 4 it can usually be approved by the national regulatory authority for use in the general population, wherein Phase 0: First in human trials; Phase 1: Screening for safety; Phase 2: Establishing the testing protocol; Phase 3: Final testing; and Phase 4: Post approval studies. Each phase has a different purpose and helps scientists answer a different question.

CLT Contact Information can be required in order to optimize the interactions between the system team in charge of the CLT and the researchers that are coordinating different areas of the CLT. The Principal Investigator (PI) is the lead scientist for a particular CLT. The PI takes direct responsibility for the completion of a funded project, directing the research and reporting the results to the scientific community and the sponsor(s) or funding agency or agencies. During the CLT progress, the PI coordinates directly or through a CRO, and monitors the parameters chosen as indicators for the correctness of CLT progression. The Principal Investigator (PI) is the lead scientist for a particular CLT. The Clinical Trial Sponsor is the Institution/Company that provides the budget for the CLT. The Clinical Trial Contract Research Organization (CRO) is “A person or an organization (commercial, academic, or other) contracted by the sponsor to perform one or more of a sponsor's trial-related duties and functions.”

Clinical Information can be required in order to define several CLT parameters that can identify subject subsets with different prognosis and risk of treatment failure and optimize the system set-up procedure. Endpoints define the efficacy of a drug or a therapeutic intervention. Depending on the Clinical Information and the Endpoints, CLTs that are most similar to the one being addressed can be identified, thereby minimizing the time required to setup system. The Clinical Information can be also important to monitor the clinical disciplines and the CLT endpoints for which system is most useful, which can include: CLT Discipline: it is the medical specialty dealing with the disease(s) object of the CLT; CLT Category: it is the CLT category as defined in http://www.clinicaltrial.gov/ct2/search/browse?brwse=cond cat; CLT Keywords: define the distinguishing characteristics of the action/drug to be tested in the CLT as well as the disease in which the action/drug are tested, and sometimes it recapitulates trial endpoints; CLT Primary Endpoint: it is the primary endpoint of the CLT; CLT Secondary Endpoint: it is the secondary endpoint of the CLT; CLT Imaging Endpoint: it is the eventual imaging related endpoint of the CLT, as defined in the CTP or as agreed with the TIC.

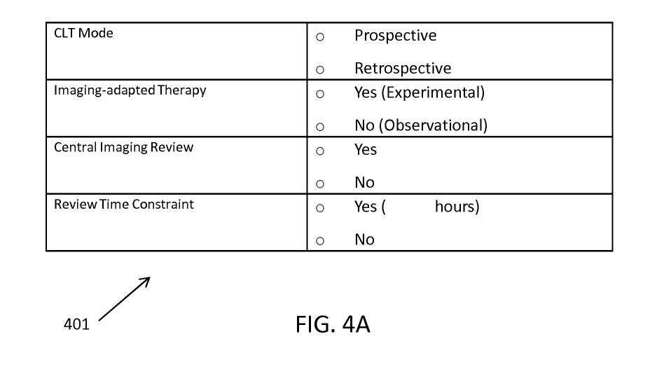

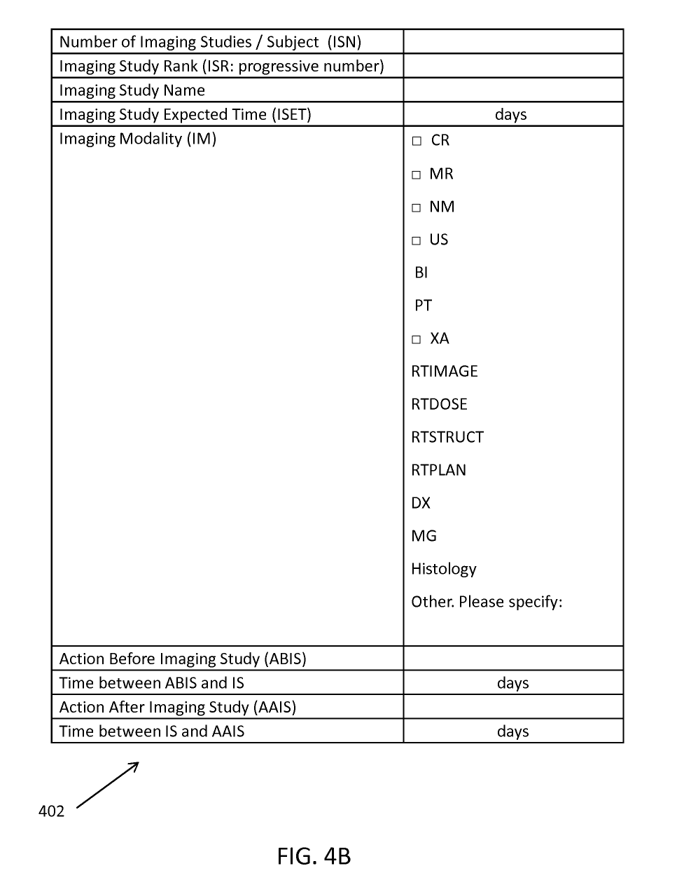

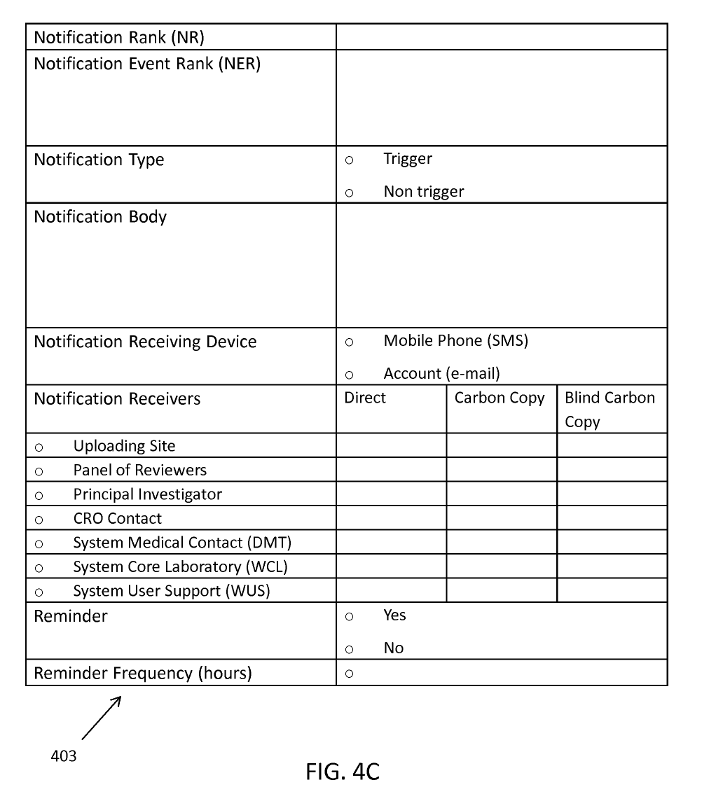

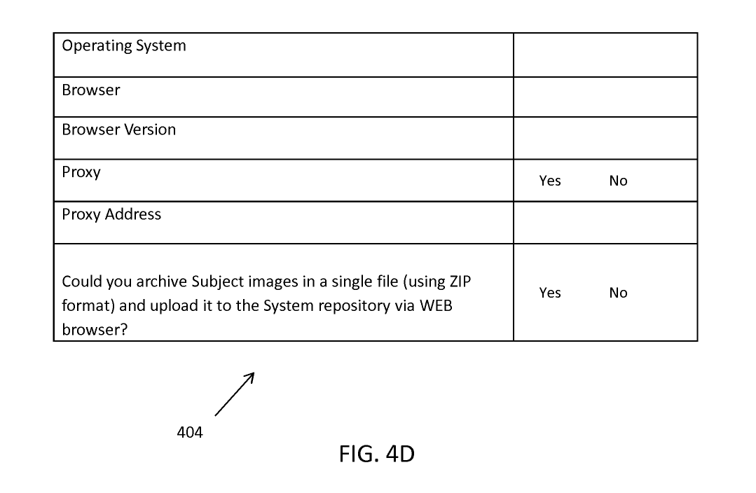

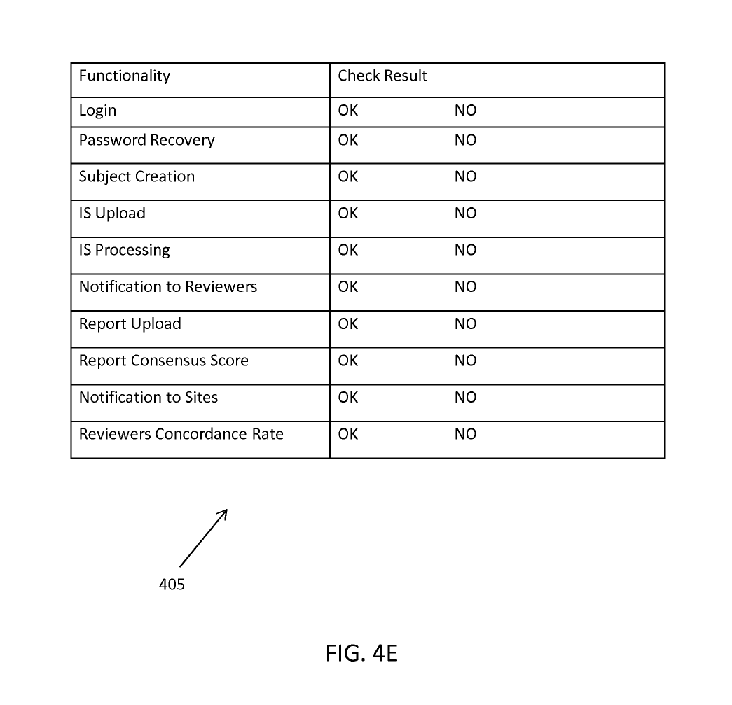

CLT Mode parameters are related to the global imaging-related features of the CTP. These parameters can be defined using data entry in a table 401 such as shown in FIG. 4A. CLT Mode it defines whether a CLT is Prospective (i.e., it can collect Imaging Studies on Subjects to be recruited) or Retrospective (i.e., it can analyze an existing image dataset); Imaging-adapted Therapy: it defines whether the Imaging Studies are dynamically used to adapt the future therapy or not; Central Review: it defines whether the ISs should be analyzed by a RP or not; and Review Time Constraint: it defines whether the CTP sets a time constraint on the Imaging Review procedure in any part of the CTP; if so, the shortest time constraint can be declared.

The parameters defining a CLT size from the point of view of system can be related to (a) the number of institutions involved (b) the sample size of the enrolled Subjects, (c) the number of IS per enrolled Subject. These parameters can be strictly related to the duration of the system configuration procedure as well as to the total amount of data to be collected and analyzed and the number of connections to the system Server. Some of these parameters can be related to the operational costs (and therefore are used in the price-definition model). These parameters can include: Number of Subjects: it is the number of Subjects to be recruited in order to reach the CLT endpoints, as foreseen by the approved CTP; Number of IS/Subject: it is the number of ISs that are performed on each Subject recruited in the CLT and that are managed by system. Additional ISs could be done in the CLT that do not require any QA/QC, qualification, review or analysis (e.g. pre-operative chest X-ray); US availability: time frame and day frame for availability of US; Number of ISGs: it is the number of ISGs (i.e., Institutions where Subjects are recruited and ISs generated) participating to the CLT. If the CLT is Retrospective, Number of Sites refers to the number of imaging data sources; and Number of Countries: it is the number of Countries in which CLT Sites are located.

With respect to clinical trial duration, the parameters defining a CLT set the expected time span in which the system Server must be available to the CLT. Some of these parameters are related to Expected Recruitment Duration: it is the expected time interval between the recruitment of the first and the last Subject; Expected IS Collection Duration: it is the expected time interval between the upload to the system Server of the first and the last IS; Expected Total Duration: is the expected time interval between the recruitment of the first Subject and the follow-up completion of the last Subject; Expected Starting Date: is the expected date of first Subject enrolment; and Expected End Date: it is the expected date for the official closing of the CLT.

With respect to imaging information (to be filled, e.g., by the system Medical Contact Person), Imaging Information can be a core of the input required to set up system services for a CLT. An example of this form is shown in FIG. 4B as table 402. Imaging Information can includes: the overall structure of the CLT Imaging Protocol, with the global workflow between the collection of the first IS and the review of the last IS for any recruited Subject; the details about the protocol, the IS data acquisition procedure, the data on QA and QC procedures, the reporting procedure for IS (with/out central review) and the events triggered by any of the IS foreseen by the protocol.

With respect to CLT imaging protocol, the basic information needed to overview the CLT Imaging Protocol and provide a first assessment on its technical feasibility can include: Imaging Study Number (ISN): it is the number of ISs foreseen by the CTP for each recruited Subject; Imaging Study Rank (ISR): it is the order number, increasing with the timeline, of the IS being addressed. It can start from 0; Imaging Study Name: it is the name assigned by the CTP to the IS (e.g., “baseline PET”, “interim-PET”); Imaging Study Expected Time (ISET): it is the time expected to pass between the Subject Time of Recruitment (TOR) and the acquisition of the IS. The IS can take place at (before) recruitment; ISET is 0 (negative); Imaging Modality: it is the modality of the IS acquisition, as selected from the available values in the DICOM standard. In case of hybrid acquisitions, all (i.e., both) the acquired modalities can be selected. The system also can support images taken with non-DICOM modalities, such as histological images; Action Before Imaging Study (ABIS): it is the action, foreseen in the CTP, that triggers the execution of the IS. For example, it can be the Subject recruitment in case of ISR #1; Time between ABIS and IS: it is the expected time interval (in days) between the ABIS and the IS acquisition; Action After Imaging Study (AAIS): it is the action, foreseen in the CTP, triggered by the execution of the IS. For example, it can be the notification of IS availability to the panel of Reviewers; Time between IS and AAIS: it is the expected time interval (in days) between the IS acquisition and the AAIS.

With respect to clinical trial imaging protocol assessment, once the appropriateness of the IS use within the CLT and the coherence with the CLT endpoints has been checked, the proposed imaging CTP can be evaluated, as the second stage of the system setup procedure. The imaging CTP is the part of the general CTP that addresses all the IS-related issues: inclusion/exclusion criteria, Subject preparation, IS acquisition and reconstruction, IS reviewing, IS reporting and analysis. While CT and MR scans can be incorporated in CLT design and implemented by a knowledgeable physician, even if not specifically expert in imaging techniques, the DMT and the WCL can support the PI with CLTs that include functional imaging techniques such as PET. Starting from the planned CLT workflow, the detailed protocol of each IS can be analyzed by the system Core Laboratory (WCL), according to the IS modality and the related specific procedures. If appropriate, an updated IS procedure is proposed. Before approving the use of a definite IS in a CLT, one can be aware of the limitations or specific requirements for a particular IS to be performed and the inclusion criteria of the CLT modified accordingly. For example, Subjects with an Implantable Cardioverter-Defibrillator, pacemaker or aneurysm clip can be excluded from any CLT in which the chosen IS is MR; pregnant women cannot undergo X-ray sessions; breast-feeding women cannot undergo any type of molecular imaging examination. For standardization purposes, the acquisition guidelines for imaging can be well described and documented in a dedicated appendix in the CTP. These guidelines include the required equipment technical settings as well as the chosen scan protocol. In an iCLT the WCL can confirm that all the required standards for image acquisition can be met by all the IGSs and that a program for regular auditing is implemented for the scan acquisition and analysis.

The specific criteria for eligibility/exclusion of a subject to undergo a definite IS can be included in the general inclusion/exclusion criteria for patient enrollment in a iCLT based on the same IS. The set of operation procedures to perform an IS can include specific recommendations for the management of Subjects with potential contra-indication to undergo a specific IS (e.g. high blood glucose level for PET/CT, claustrophobia for MR, renal failure for CECT, etc.). Time points of ISs are defined independently in each CTP depending on the specific diagnostic question. Within a definite CLT the ISs can be planned in precise time-points during the CTP workflow and in a temporal relation with the medical/therapeutic intervention; other interventions (e.g. chemotherapy, radiotherapy or prior treatment). An IS is referred to as “baseline” IS when it is acquired for staging purposes before therapy onset. The time interval between the baseline IS and the treatment initiation can be specified as well as the time intervals between subsequent ISs and treatment cycles. Additionally, the IS protocol can specifically define an acceptable timing variance for acceptable performance of ISs around each time-point at which an IS is specified (i.e., the acceptable time window during which the IS may be considered “on schedule”). Activities, tests, drugs and interventions that might increase the chance for false positive and/or false negative results can be avoided prior to scanning. The allowable time interval between the confounding event and the IS acquisition depends on the nature of the confounder. Tests that might confound the qualitative or quantitative results of an IS can be avoided in the time period prior to the IS. The IS session is considered in terms of three distinct time intervals: prior to the IS session (prior to Subject arrival and upon arrival); during the IS session; post IS session completion. The Subject preparation before the IS session includes dietary or other physical performances, as specified by the CTP. The adherence to the prescriptions can be verified and certified by the Recruiting Site staff. Upon arrival the following tasks can be completed: confirmation and certification of Subject compliance with pre-procedure instructions; occurrence of potentially confounding events can be documented on the appropriate case report forms. There can be documentation about Subject-specific risk factors including (but not limited to) previous contrast reactions (e.g. if the use of iodinated or gadolinium contrast dye is planned). With respect to preparation for IS session, the Subject-specific preparation includes administration of liquids or foods, to help the Subject acquire a physiological state. Before or during a specific IS some drugs may be administered to enhance the diagnostic quality of the IS itself (e.g. pertiroid administration in scintigraphy, beta-blockers in Angio-CT) or to enhance patient's compliance (e.g. benzodiazepines to prevent claustrophobia). The dose and time of administration are set a priori and identical for all the patients undergoing the IS, because a deviation in administration schedule could influence the IS itself. IS is often accompanied by the administration of contrast media or, in case of nuclear medicine examination, radiopharmaceuticals that are to be prepared according to the pharmacopeia. The use of contrast media/radiotracer is clearly described in the CTP. The exact dose and the time at which it is calibrated can be recorded. Residual dose remaining in the tubing, syringe or automated administration system or any dose spilled during injection can be recorded, and can specify which is the contrast agent/radiotracer administration route (e.g.: oral, intravenous, Central Venous Catheter (CVC), etc.).

All ISs for an individual Subject are performed on the same scanner hardware and software throughout the CLT or on a twin qualified equipment. In the event of equipment malfunctioning, follow-up ISs on an individual participant can be performed on a different scanner of the same model and software version, provided it has completed the scanner qualification process. An IS is composed of different series depending on the CTP. The different series inside an IS could encompass images acquired with different IMs (e.g. PET+CT), images acquired in different time phase (CT+CECT) or images acquired within the same IM but with different acquisition parameters (MRI with different T1 and T2). The above information as well as the typology of IS are described in detail in the CTP. For example, as an illustrative specification, the matrix size, slice thickness and reconstruction zoom can yield a target voxel size of 3-4 mm (PT), 0.5-1 mm (CT, MR), 0.1 mm (MG) in all dimensions, although not necessarily isotropic. For example, the spatial resolution should not be achieved by re-binning the reconstructed images. The detailed description of the scanning procedure itself, depending on the IM and the CTP. Images can be acquired at different time points during IS execution, according to specific scanning or image acquisition procedures planned in a definite CTP. Consistent positioning avoids unnecessary variance in attenuation, changes in gravity-induced shape and fluid distribution, or changes in anatomical shape due to posture, contortion, etc. The limits of scanning coverage in the cranio-caudal, antero-posterior and medial-lateral directions of the human body (e.g. whole body PET is defined from orbital meatus to mid-femora) and the direction of scanning (e.g. cranio-caudal) can be clearly stated as part of the CTP and the Sites can comply to the instructions. Reconstructed Image Data (RID) refers to data exactly as produced by the reconstruction process on the scanner, i.e., a stack of DICOM slices/files constituting an IS image volume with no processing other than that occurring during image reconstruction. RID can be analyzed on one or more of the following workstations: scanner console, image display workstation, PACS system, WEB Viewer, etc. Post-Processed Image Data (PPID) refers to data transformed in some manner, including but not limited to: smoothing, sharpening, zooming, rotating/translating, resampling, interpolating, slice averaging, MIP (Maximum Intensity Projection), etc. PPID is typically a stack of DICOM slices/files constituting an IS image volume that was analyzed (i.e., post-processed) after reconstruction on one or more of the following workstations: scanner console, display workstation, PACS system, WEB Viewer, etc.

With respect to IS data storage and transfer, the IS DICOM format can meet the Conformance Statement written by the scanner manufacturer. DICOM data shall be stored and/or transferred without any compression causing loss of information. The IS analysis, through interaction with the Workstation Analysis tools, can perform certain measurements planned in the CTP. IS Analysis can include qualitative and quantitative measures. Both require consistency and high quality images. Quantitative PET imaging also requires additional characteristics described elsewhere. The output images of Reconstruction and Post-processing software activity are considered the input for Image Analysis. If the Image Analyst alters input data (e.g. zooming) this is considered part of Image Analysis activity. With respect to methods to be used, each tissue/organ to be investigated quantitatively calculating one or more parameters in a reproducible way. The system can support any IM that can be stored in a DICOM file hierarchy. That includes the most frequently used IMs, such as Mammography (MG), Computed Tomography (CT), Positron Emission Tomography (PT), Magnetic Resonance (MR) as well as less common IMs. Moreover, system can exchange images stored in a format other than DICOM, although in that case it cannot provide standard treatment of the uploaded images (i.e., compliance checks and so on). Among non-DiCOM images, it is particularly promising the role of Histology in the global and imaging-related workflow of a CLT.

Histology can be an important factor for the selection of Subjects to be enrolled in a CLT. In several CLTs a central retrospective review of the histological diagnoses from biopsy blocks is planned. This process requires a centralization of paraffin-embedded biopsy blocks: it is time consuming and often expensive. Quite recently digitalization of images acquired by an optic scanner made central histologic review possible. This can be achieved in two ways: a) with a dynamic image acquisition readily available in a central review laboratory via Virtual Private Network (s). In this case the reviewers see the image acquired by a traditional optic microscope in the local pathology Site and remotely drive the mechanical stage of the microscope to find the images of interest; b) with a full scanning of the histological images present in a slide in the local pathology Site and subsequent transmission of the images in JPEG format via Web to the review Site, where the reviewers rely on the entire morphologic information contained in a slide or in a few slides. The advantage of electronic accessibility of histological images is the possibility of a timely histological review from a newly diagnosed Subject in order to allow the enrolment in a CLT.

With respect to image quality, different IMs are used in CLTs, depending on the IS role. The WCL can certify and/or update the imaging protocol as described by optimizing it to the proposed IMs. For each IS foreseen by the CTP an image quality minimal requirement can be defined and a QA procedure created accordingly. The image quality minimal requirement information might not be available from the CTP and/or may be subject to update according to the expertise provided by the WCL. The image quality characteristics to be addressed can vary depending on the IM. For example, spatial resolution and high contrast for DX; the same characteristics plus low contrast for MG; spatial resolution for US; spatial resolution, low contrast, homogeneity, and uniformity for MR; spatial resolution, high and low contrast for CT; and spatial resolution and sensitivity for PT, and so on. QA procedure and the QP to include/exclude Sites fulfilling these requirements can be defined accordingly. IS parameters in a CTP can be adjusted to select one of the image quality characteristics (for instance the sensitivity can be increased at the expense of spatial resolution). The standardization of imaging acquisition and processing is a required step but does not comprehensively cover the process of data validation. For example, as stated before, the reproducibility of the data is strongly influenced by the reporting protocol. In order to standardize the review process done by the physicians, a structured reporting form can be agreed, in which all the requested information is provided by all the Reviewers.

The Reviewer Report can be obtained in several ways. ISs are analyzed (visually) with a DICOM Viewer. If the CTP specifies a common DICOM Viewer to be used for reporting, its name and vendor can be provided. ISs are analyzed with a Software Tool that extracts some metrics. If so, the Software Tool name, version and vendor can be provided. For example, Oncology CLTs currently using RECIST criteria commonly include confirmatory evaluation of the overall response pattern to verify that the quantitative RECIST outcome is in agreement with the radiologist global evaluation.

Response Evaluation Criteria In Solid Tumors (RECIST) can be a set of published rules that define when cancer patients improve (“respond”), stay the same (“stabilize”), or worsen (“progress”) during treatments. The criteria were published in February, 2000 by an international collaboration including the European Organization for Research and Treatment of Cancer (EORTC), National Cancer Institute of the United States, and the National Cancer Institute of Canada Clinical Trials Group. Today, the majority of CLTs evaluating cancer treatments for objective response in solid tumors are using RECIST. Only Subjects with measurable disease at baseline can be included in protocols where objective tumor response is the primary endpoint. All measurements can be taken and recorded in metric notation, using a ruler or calipers. All baseline evaluations can be performed as closely as possible to the beginning of treatment and never more than 4 weeks before the beginning of the treatment. CT and MRI are the best currently available and reproducible methods to measure target lesions selected for response assessment. Conventional CT and MRI can be performed with cuts of 10 mm or less in slice thickness contiguously. All measurable lesions up to a maximum of five lesions per organ and 10 lesions in total, representative of all involved organs can be identified as target lesions and recorded and measured at baseline. Target lesions can be selected on the basis of their size (lesions with the longest diameter) and their suitability for accurate repeated measurements (either by imaging techniques or clinically). A sum of the longest diameter (LD) for all target lesions can be calculated and reported as the baseline sum LD. The baseline sum LD can then be used as reference to characterize the objective tumor response. Tumor response to treatment in the target lesions are defined as follows: Complete Response (CR): Disappearance of all target lesions; Partial Response (PR): At least a 50% decrease in the sum of the LD of target lesions, taking as reference the baseline sum LD; Stable Disease (SD): Neither sufficient shrinkage to qualify for PR nor sufficient increase to qualify for PD, taking as reference the smallest sum LD since the treatment started; Progressive Disease (PD): At least a 20% increase in the sum of the LD of target lesions, taking as reference the smallest sum LD recorded since the treatment started or the appearance of one or more new lesions.

While computer algorithm-based IS analysis is an increasingly used component of outcome evaluation in CLTs, the importance of expert readers has not diminished. In the early phase studies of drug bioavailability and quantitative targeting, the role of expert readers is particularly important in later stage CLTs, in which the identification and quantification of individual tumors or other anatomical structures is performed by expert readers with increasing software support. However, the barriers to broad regulatory acceptance of quantitative computer algorithms and the absence of transparent pathways to approval can continue to maintain a central role for the expert reader. In case a Computer Assisted Detection (CAD) tool can be required as part of the IS processing: if the CAD algorithm already exists, it can be identified by its name, version and vendor; if it can be developed, a document describing the requirements and the expected features and performance can be attached.

With respect to the review panel, whenever criteria of IS interpretation are unsettled or the IS has been planned in a different clinical context than the one in which the IS is usually performed, a RP should take responsibility for the diagnosis in an iCLT. The RP performance itself can be assessed in an iCLT whenever precision and accuracy of a reporting procedure is among the CLT endpoints. Several aspects can be taken into account during the selection of reviewers for a definite CLT. In absence of specific requirements established in the CTP, the following criteria can be set: proven experience in the field; previous participation as reviewer to iCLTs; geographic area in relation to the distribution of CLT imaging Sites in the same region. Besides the above-mentioned requirements a specific skill for a definite IS technique could be necessary. In this case a specific learning program with a training set of images can be planned. This functionality can be implemented in remote mode thanks to System®: a set of ISs is loaded to a specific system learning website and Reviewers are asked to report the ISs. The Reviewers can use their own workstation (i.e., DICOM viewer) to assess the ISs. Reviewers are then asked to report the ISs using the same interpretation key and filling the standard report form planned in the CTP. The IS Panel Report (RP) generates a number of single IS Reviews, which can be used as input for the generation of a single, combined Panel Report, according to the CTP requirements.

Several methods can be used to generate a Panel Report: the hypothesis of imaging reader bias assumes that the reader systematically either over- or underinterprets tumor shrinkage. For example, differences in response rates determined by investigator and independent assessments have been documented in many studies, with the latter frequently reporting lower response rates, especially in single-arm phase II studies. In RCT, imaging reader bias assumes that the reader's interpretation can be influenced by his/her knowledge of treatment assignment in a way that results in an incorrect assessment of the therapy's effect on treatment outcome. Blinded Independent Central Review (BICR) of IS to assess treatment outcome in CTs has been advocated to control bias that might result from errors in treatment response assessment. BICR was found to reduce the measurement variability (measurement error; i.e., random discrepancies unrelated to treatment). Even with blinded assessments of images, two readers may disagree on the disease progression status, especially with borderline or complex cases. Furthermore, discrepancies may result from tracking different target lesions or from missing the development of a new lesion that is small at its first appearance. Discrepancies alone do not indicate systematic bias in the evaluation of the treatment effect. Central Review by a small number of Reviewers with expertise in the CLT specific area may lessen the measurement variability. Another important consideration in minimizing measurement variability is to ensure that all Reviewers are evaluating the same full set of ISs for any given Subject. The Reviewers Concordance Rate (RCR) can be used to quantify discrepancies among Reviewers. In a CLT where the BICR result triggers the treating physician's decision, the Combined Report evaluation is the basis for any decision to continue or alter treatment. This task can be easily accomplished in non-interventional, observational CLTs in which a retrospective IS Central Review is required. Time constraints are no longer a problem and the BICR would progress at a pace depending on IS flow from local Sites to the Central Review Core Laboratory. The situation is completely different for RCTs, where BICR results in a number of complications. Perhaps the most serious problem occurs when the locally determined progression time occurs before the BICR-determined time. Local Review is an alternative option to BICR. For all ISs (or just ISs that are near the boundary of progression), another possibility is to perform at least one additional IS after local progression is called. The presumption is that more reliable documentation of radiologic progression from a Central Review is likely with an extra IS. Blinding the Local Reviewer to treatment outcome and using her/his Report exclusively for treatment response evaluation would eliminate the potential for biased endpoint evaluation. A potential for bias arises when the clinical investigator, with knowledge of treatment response, uses radiologic evaluations, but makes the definitive determination on clinical Subject evaluation and IS result. Clinical information, in fact, could disclose factors unrelated to the pathologic condition for which the IS is used to assess treatment response that possibly affect the test performance. With respect to notifications, the CTP assessment includes the definition of the list of events that require some kind of information be notified to one or more CLT players. These events are labeled as ‘Notifications’. Notifications can be either dynamical (i.e. triggered by a well-defined event) or asynchronous (i.e. happening at a pre-defined time checkpoint during the CLT progress). The list of dynamical and asynchronous Notifications and the people who can receive them can be agreed by the PI and the DMT.

With respect to clinical trial imaging protocol, tables can be used to collect imaging-related information required to setup system by configuring: the CRO Interface; the Core Laboratories procedures required for the pre-trial QC and the QA actions during the CLT operations; and the CLT custom WEB-site that implements the workflow foreseen by the CTP. In addition, whenever a reporting procedure is part of the iCLT protocol, several steps can be defined: the Report by the Single Reviewer; the Composition of the Reviewer Panel; and the Consensus Rules for the Combined Report. The information that identifies the IS is collected for each IS foreseen by the CTP, which can include Imaging Study Rank (ISR): it is the order number, increasing with the timeline, of the IS being addressed. It can start from 0; Imaging Modality: it is the modality of the IS acquisition, as selected from the available values in the DICOM standard. In case of hybrid acquisitions, all (i.e., both) the acquired modalities can be selected system also supports images taken with non-DICOM modalities, such as histological images; Use of Imaging: it described the reason for which the IS is part of the CTP; Exclusion Criteria: it can list the conditions that would determine the exclusion of an individual from the IS and (eventually) from the CLT; Inclusion Criteria: it can list the conditions that can be met by any individual in order to be eligible for the IS and (eventually) the CLT, according to the CTP; and Contraindications: it lists the conditions that can be potentially harmful for a subject undergoing a definite IS (e.g. allergies, metal implants, claustrophoby, etc.).

Any non-standard procedure related to the Subject preparation, the data acquisition, reconstruction and post-processing can be listed, including the information that is to be assessed by the DMT and the CL, and feedback may be provided, including Imaging Study Rank (ISR); Dose Optimization: it specifies any non-standard information on the procedure that is carried out to decrease the radiation risk associated to exposure to ionizing radiation or electromagnetic field; Subject Preparation: it lists non-standard requirements related to the Subject preparation procedure for the IS; IS Acquisition: it lists non-standard requirements related to the IS acquisition procedure for the IS; IS Reconstruction: it lists non-standard requirements related to the IS reconstruction parameters for the IS; IS Processing and Analysis: it provides information about the IS post-processing (qualitative, semi-quantitative, quantitative) foreseen by the CTP; IS Meta-Information at upload time: it defines whether or not meta information (i.e., any information about observable relevant to the CTP but not stored in the DICOM data) is to be associated to the IS when it is uploaded to the system Server. Details about the Meta-Information, if required, can be provided in tabular form; IS Validation Process: it declares whether or not an IS validation procedure is to be carried out on the IS. Details about the validation process, if required, can be provided in tabular form; IS CAD Processing: it declares whether or not an IS automated processing with Computer Assisted Detection (CAD) Algorithms can be run on the system Server; and Core Laboratory Functionality: it declares whether or not an equalization and calibration of the devices acquiring the IS across the different Sites involved in the CLT is required. If any Meta-Data information (i.e., any information about observable relevant to the CTP but not stored in the DICOM data) can be associated to the IS when it is uploaded to the system Server, it can listed in tabular form, together with the acceptable range (if any) and the Unit; including, which for each instance can be filled for each IS foreseen by the CTP: Imaging Study Rank (ISR): it is the order number, increasing with the timeline, of the IS being addressed. It can start from 1; IS meta-data information required at upload time: it defines whether or not meta information (i.e., any information about observable relevant to the CTP but not stored in the DICOM data) is to be associated to the IS when it is uploaded to the system Server; and Observables: it is the list of observable parameters (e.g., the blood glucose level) that, according to the CTP, can be recorded during the IS session. For each observable, the Name, Unit, the Expected value, the Minimum and Maximum acceptable values, can be declared. If any validation procedure on the DICOM data is required after uploading the IS to the system Server, its details can be listed in tabular form, as filled for each IS foreseen by the CTP, including Imaging Study Rank (ISR): it is the order number, increasing with the timeline, of the IS being addressed. It can start from 1; IS Validation Process: it defines whether or not an IS validation procedure is to be carried out on the IS; DICOM Validation Checks: it is the list of DICOM TAGS to be automatically checked on the IS (i.e., the presence of a given DICOM TAG and the compliance of its value to the acceptable interval). For each requirement, the DICOM TAG Identifier, the Unit, the Expected value, the Minimum and Maximum acceptable values, can be declared. With respect to CAD processing, if any CAD-based IS processing is required after uploading the IS to the system Server, its details can be listed in tabular form for each IS foreseen by the CTP, including Imaging Study Rank (ISR): it is the order number, increasing with the timeline, of the IS being addressed. It can start from 1; IS CAD Processing: it defines whether or not an IS automated processing with Computer Assisted Detection (CAD) Algorithms can be run on the system Server; CAD Processing Algorithm: it specifies which CAD algorithm can be run on the IS. If existing, information about the provider and the expected output can be provided.

With respect to the DICOM viewer, if any DICOM viewer is required for the IS processing, its specifications can be listed, such as including Imaging Study Rank (ISR): it is the order number, increasing with the timeline, of the IS being addressed, and it can start from 1; DICOM Viewer: it defines whether or not a specific and common DICOM Viewer is required to run on the system Server for the Reporting procedure; and Requested DICOM Viewer: it specifies which DICOM Viewer (Name, Vendor, Version) is required. For a single reviewer report, listed specifications can include Report Rank (RR): it is the order number, increasing with the timeline, of the Report being addressed. It can start from 0; Clinical question: it is the question addressed to IS by the CLT; Description: it contains a description of the images. It can be written as a list of observable; Conclusion: it declares which are the results of the reviewing process; Final results: it is the part of the conclusion that is used to create the combine report; Advice: it is a medical advice for other testing or possible therapies; Notification text: any information that the IS referring physician want to communicate to other actors of the CLT; Notification to: receivers of the notifications (e.g., physician, PI, WCL, WUS, other); and Notification priority: priority of notifications to be settled depending on type of notification (e.g., high, normal, low). If any reporting procedure on ISs is foreseen by the CTP, the related information can be collected in tabular form. A PI or CRO evaluates the reviewer skill, where necessary or required, for example, and not a system administrator who is not also a PI. An instance of a table can be required to be filled for each Report foreseen by the CTP, including for Report Rank (RR): it is the order number, increasing with the timeline, of the Report being addressed. It can start from 1; Number of Reviewers: it is the number of Physicians concurring in determining the Report Result; Report Features: it describes how the Report information is being collected with respect to the Reviewers location (Local, Central, Distributed) and their number (Single, Multiple); Report Mode: it describes the modality for the Report generation; Report Processing: it certifies whether the processing of the Report Result (Content) can be carried out by system or not. With respect to the reviewer panel, if any Multiple Report on ISs is foreseen by the CTP, the details about the Reviewers Panel selection and training procedures can be provided, as well as the contact information for the Panel Members. If several Reports are foreseen by the CTP, an instance of a table can be filled for every Report, including for Report Rank (RR): it is the order number, increasing with the timeline, of the Report being addressed. It can start from 1; Reviewers Selection: it declares whether it is required to select the Reviewer Panel Members; Reviewers Skill Assessment: it declares whether it is required of the PI or CRO to assess the skills of the Reviewer Panel Members; Reviewers Skill Assessment Method: it declares how the skills of the Reviewer Panel Members can be assessed; Discordance Analysis on Single Subjects: it declares whether the analysis of the Discordance between Single Reports by different Reviewers on the same Subject is required or not; Reviewers Training: it declares whether it is required to set-up a training procedure for the Reviewer Panel Members; and Reviewers Pre-CLT Performance Assessment: it declares whether it is required to assess, with an automated procedure, the performance of the Reviewer Panel Members before starting the CLT. Reviewer Information can be required in order to create her/his credentials on the system Server as well as, if required, setting up the training and performance assessment procedures. For each member of the Reviewer Panel, an instance of tabular information to be filled in with associated identifying and contact information. If any Multiple Report on ISs is foreseen by the CTP, the related information can be collected in tabular form, which can be filled for each Multiple Report foreseen by the CTP, including for Report Rank (RR): it is the order number, increasing with the timeline, of the Report being addressed. It can start from 1; Report Combination Rules: it describes the rules to be adopted when combining single Reports by different Reviewers in order to generate the Multiple (Combined) Report (i.e., the Consensus); Minimum Average Concordance Rate (%): it declares the minimum acceptable value (%) of the global concordance rate by the Reviewer Panel; Concordance Rate between Reviewer Pairs: it declares whether the analysis of the Concordance Rate between Reviewer Pairs is required or not (e.g., as “yes” or “no” click boxes); Minimum Concordance Rate between Reviewer Pairs (%): it declares the minimum acceptable value (%) of the concordance rate between any Reviewer Pair; Discordance Analysis on Single Subjects: it declares whether the analysis of the Discordance between Single Reports by different Reviewers on the same Subject is required or not (e.g., as “yes” or “no” click boxes); and Maximum Discordance on a Single Report: it declares the maximum acceptable value (report scale units) of the discordance between IS reporting by any two members on the Reviewer Panel.

Notifications Events (NEs) can define the logical conditions that, during the CTP, generate the request for one or more notifications. NEs can be ranked with an increasing label called Notification Event Rank (NER) and are defined by one and only one logical condition. Each NE can be associated to one or more Notifications. A tabular form can be required to be filled in and submitted for every CTP, including information for Notification Event Rank (NER): it is the order number, increasing with the timeline, of the Notification Trigger Event being addressed. It can start from 1; and Event Logical Condition: it describes the logical condition that defines the event generating one or more notification requests (e.g., the availability of ISR1 and ISR3). Notifications can be an essential functionality in order to efficiently implement the CTP. Notifications are triggered by specific actions in the CTP and, in turn, trigger following actions. Their role is particularly important whenever time constraints are part of the CTP. As for the ISs and the Reports, Notifications can be ranked so as to uniquely identify them. The parameters that describe a given notification can be listed in tabular form, such as exemplified by table 403 in FIG. 4C, wherein the form can be filled for an instance thereof for every Notification foreseen by the CTP, wherein Notifications could trigger or not an event in the CLT workflow; wherein parameters can be Notification Rank (NR): it is the order number, increasing with the timeline, of the Notification being addressed. It can start from 1; Notification Event Rank (NER): it is the order number of the event (i.e., the logical condition) that, at completion, triggers the Notification. For example, it could be a successful IS upload, that triggers a Notification to the Reviewer Panel; Notification Type: a notification could trigger (or not) an event in the CLT workflow. In the case of a trigger event the event triggered is clearly stated; Notification Body: it is the content of the message to be sent; Notification Receiving Device: it lists the destinations for the Notification. Supported destinations are a Mobile Phone (SMS) or a Computer Account (e-mail); Notification Receivers: it lists the people (i.e., their roles) that can receive the Notification. It also provides the option to select whether the Notification should be sent directly or as a (blind) carbon copy; Reminder: it declares whether or not a reminder can be sent; and Reminder Frequency: it defines the required frequency (in hours) for the Notification Reminder.

With respect to a clinical trial protocol assessment form, a system Medical Contact can be responsible for: the assessment of the clinical and imaging CTP; and the gathering of all the information required by the WCL and DST in order to implement the CTP. The system Medical Contact can suggest modifications to the clinical/imaging parts of the CTP and notifies the PI; or approves the CTP. Amendments to the CTP can be requested by the Principal Investigator. If they have any impact on the CLT Operations, an addendum can be agreed by the system Medical Contact and the Principal Investigator.

### Part II

With respect to an interface to the CRO, a Contract Research Organization (CRO) is a service organization that provides support to the pharmaceutical and biotechnology industries in the form of research services outsourced (often domestically) on a contract basis. Recently, CROs assistance to independent academic or company-sponsored CLTs has become more and more frequent. The International Conference on Harmonization-Good Clinical Practice (ICH-GCP, E6 1.20) defines a Contract Research Organization (CRO) as: “A person or an organization (commercial, academic, or other) contracted by the sponsor to perform one or more of a sponsor's trial-related duties and functions.” A CRO can provide such services as biopharmaceutical development, preclinical research, clinical research, and CLT management. Many CROs specifically provide clinical-study and CLT support for drugs and/or medical devices. CROs range from large, international full-service organizations to small, niche specialty groups. CROs that specialize in CLT services can offer their customers the expertise of moving a new drug or device from its conception to FDA/EMA marketing approval, without the drug sponsor having to maintain a staff for these services. In order to properly configure system, the system/CRO interface can be defined in detail. Input information is required from the CRO in the CLT configuration stage, before the starting of the Subject recruitment. The system User Support (WUS) can ask the CRO contact for the information required to configure system, which can be basically the following: list of CLT Sites; list of local Site Contact Persons. The information about CLT Sites can come from the CRO, not the PI directly, in order to make sure that there are no discrepancies. From the point of view of CLT operations, a definition of the interactions between system and the CRO is provided. The CRO triggers the system availability to users, while the completion of imaging-related tasks handled by system can provide feedback to the CRO. Recruited Subjects can be added to the system CLT database by the CRO Contact, either manually via the WEB interface or automatically via an Application Program Interface (API), such as to be defined in a separate agreement between the system medical team and the CRO. As soon as a new Subject is inserted, the system sends an Acknowledgement Notification to the CRO Contact as well as a notification to the Site that recruited the Subject, to let it know that system is ready for uploading ISs. The Notification is one of the Notifications foreseen by the CTP, as can be described in tabular form. Information on the Number of Sites that can recruit Subjects in the CLT and the information to contact the participating sites can be collected.

With respect to clinical trial sites qualification processing, both physiological and physical factors can influence the accuracy and reproducibility of ISs in clinical practice. For example, variations in PET scanner calibration, image reconstruction and data analysis and/or settings can lead to more than a 50% variation on the measured SUV, and hence on the IS reliability for quantitative analysis. Whenever ISs are part of a CTP, the reliability of the imaging results depends on different factors, such as: the implementation of a Site Qualification Process (SQP) that, in the CLT preparation stage, verifies that the imaging equipment in all the participating Sites is properly equalized and configured; the implementation of a dynamic Imaging Study Validation (ISV) procedure that, on every IS, verifies the compliance to the CTP (i.e., the presence and reliability of all the information required to optimize the IS Review process). This procedure is referred to as “real-time auditing.” The implementation of a Reviewing procedure comprising simple and reproducible rules for IS referral and of a Reviewer Panel of experts for the IS modality. The SQP is part of the system Core Laboratory (WCL) activities. If required by the CLT, it can be carried out before the starting of the Subject recruiting stage.

With respect to the system core laboratory, the activities related to the SQP and the Auditing tasks during the CLTs operations are coordinated by the system Core Laboratory (WCL). The WCL is a team of Medical Physicists Experts (MPE) with expertise on Radiotherapy and Imaging. The WCL performs both SW and HW IS analysis and processing. The SQP is carried out through the system platform. If a SQP is required by the CLT, the first step is the assessment of the SQ status of Sites involved in the CLT for the requested IMs. In order to start a SQP, the following input information can be required: List of Site Contact Persons; List of ISs and IS Modalities. Sites can go through the SQP as described in the following. Sites which are already qualified as part of another CLT SQP can be accepted if they comply to the CLT qualification requirements. If any of the following conditions apply, the Site can start the SQP: the Site is not Registered in system-Corelab; the Site is Registered in system-Corelab, but the SQP for one or more CLT ISs is not completed; the Site is Registered in system, but its SQ status is not valid for the proposed CLT. If SQ is required, the WUS can contact the Site and send proper instructions to start the procedure. The SQ status can be updated with a frequency that is defined by the CTP. The SQP renewal can require a full process iteration or a subset of it, as specified in the CTP. As soon as the list of Sites that are to go through the SQP is defined, the process can start, in parallel, for each of them. The SQP is organized in five steps, which are described in detail in case of SPQ in a multicenter CLT based on PET functional imaging. Four steps require data collection from the Site, while the last one is a Data Analysis procedure centralized at the CL. The SQP process can have five steps, listed as follows: Site Contact Information (WUS); Imaging Questionnaire (Site); Device Calibration, through Phantom Test (Site); Test Subject (Site); and Data Analysis (WCL). The SQP output is the list of Qualified/Not qualified Sites, for which notification is provided to the WUS, the Site Contacts, the PI, the TIC and the CRO Contact. The requirements on the SQP become more and more relevant when the intended use of ISs is quantitative. In a CLT where the applied IM is morphological, such as CT, it is usually possible to treat the ISs quantitatively, as long as some preliminary inter-scanner calibration has taken place. Morphological properties (i.e., the density) are changing very slowly with time and they do not depend on physiological processes happening on a timescale comparable to that of the IS acquisition. In these situations, when the IS is stored in absolute units (such as Hounsfield units for CTs), a SQP process is either not required or simple. On the opposite, complex image acquisitions such as in MR Spectroscopy, Diffusion Weighted, Perfusion, Angiography and Functional require the set-up of a SQP to assure the repeatability between Site. When FI is involved, several processes can invalidate a quantitative analysis of the ISs. These processes and the procedure to keep them under control are described in detail in the case of FDG-PET. In Oncology FDG-PET studies, for example, variations in PET camera calibration, image reconstruction and data analysis and/or scanner settings can lead to more than a 50% variation on the measured SUV, and hence on the IS reliability for quantitative analysis. Therefore, the IS quantitative evaluation in multi-center Oncology PET-based CLTs requires a common inter-Site calibration procedure in order to assure the uniformity of ISs across different Sites. The aim of the SQP is to assure that ISs acquired in different Sites are comparable (to the extent required by the CLT). To do this a three-stage process is required: Scanner qualification; PET procedure qualification; Phantom and Subject Test.

With respect to scanner and ancillary equipment qualification, preferably only state-of-the-art PET or PET/CT scanners are generally admitted to SQP. The scanner can be a total-body scanner with high sensitivity and spatial resolution. The scanner should apply corrections for random, scatter, dead time, block efficiency and non-uniform attenuation. Each PET scanner has different characteristics that are mainly determined by the crystal type and arrangements and by the read-out electronics. The CLT Sites cannot modify the scanner configuration after the calibration phase. Usually the calibration is done locally at installation and then periodically (typically every 3 months) to correlate the known activity in a homogeneous phantom to the actual counts by the PET scanner. For the PET scanner Calibration Procedure it is mandatory to use a reference standard that can be either a ¹⁸F source measured with a calibrated radioactivity calibrator or a calibrated ⁶⁸Ge phantom. All the ancillary equipment used in activity (dose calibrator and clocks) and body weight measurements can be calibrated.

The SQP process as described herein can be assured in PET ISs by the use of the Plug-and-Play PET Phantom (P4) toolkit such as described herein. With respect to PET procedure qualification, despite the use of calibrated equipment the IS is comparable only if the PET procedure is harmonized between different Sites. The PET procedure includes Subject preparation, image acquisition and reconstruction. The system promotes imaging harmonization between Sites based on procedure guidelines published by the EANM, SMN, ESR and RSNA scientific societies. The IS protocol is verified for the first time (i.e., statically) during SQP to assess the Site imaging capabilities (i.e. that the Site is able to fulfill the IS protocol), then every time an IS is uploaded to system (i.e., dynamically). The SQP process as described herein can be assured in PET IS by the use of the Qualification Quantification (Q2) toolkit such as described herein. The information about the PET scanners available at different Sites can be collected by means of several forms, accessed via the system Core Laboratory Server. The first form can focus on the Site Contact Information, the second on the PET Scanner Technical Specifications. The information provided by the Sites in the PET Scanner Technical Specifications can be compared to that directly obtained from DICOM header data contained in the Phantom and test Subject scans. The information about possible ongoing Quality Control (QC) Programs at the Sites is required to match with the CLT-specific SQP. Quality Assurance (QA) is set up in order to monitor the scanner stability over time, in adherence to international or national standards. A documented scanner Quality Assurance program can be in place and records kept, covering daily, monthly, quarterly and annual QC testing. The WCL can ask a copy of the record during Auditing sessions. The required QC information, to be obtained as part of the QA program, is the following: Daily QC: it can determine whether the scanner is functioning well; in other words, to establish detector failure and/or electronic drift. Most commercial systems are equipped with an automatic or semiautomatic procedure for performing daily QC. For some PET/CT systems, the daily QC includes tuning of hardware and/or settings. In all cases, all daily QC measurements can be performed according to the manufacturer's specifications; and Periodical QC: it can determine whether the PET Scanner response is stable as compared to its original specifications, acquired during acceptance tests. These specifications include block calibration/set up and normalization, sensitivity, uniformity, spatial resolution, count rate loss, scatter, random and attenuation corrections accuracy, image quality, scanner alignment.

With respect to phantom tests, depending on the type of IS reporting and on the expertise of the Local Site a different phantom approach is used. The Phantom approach is discussed between DMT, PI and WCL depending on the CLT. With respect to a local phantom test, to assess the inter-scanner variability the ISs (PET scans) of two Phantoms (a Uniform and a NEMA/IEC Image Quality Phantom) can be acquired using the same acquisition and processing parameters that can be used for the Subject ISs and then uploaded to the WCL Web Server. Phantom ISs are acquired by a Medical Physicist (or equivalent qualified professional), whose contact information can be available to the WCL. For example, for a Uniform Phantom: a cylindrical phantom with a volume of about 6-9 L and a diameter of 15-25 cm. Both ⁶⁸Ge and ¹⁸F/¹⁸F-FDG filled phantoms are accepted. An example of how to perform the test is therein specified but Sites could adhere to different international and national protocols to perform the test. In short, the procedure can be as follows: a syringe is filled with approximately 70 MBq of ¹⁸F/¹⁸F-FDG solution and is re-measured in a calibrated activity calibrator (or the syringe is ordered from a pharmaceutical company). The ¹⁸F/¹⁸F-FDG is then introduced into the uniform phantom filled with water, which results in a solution containing an exactly known activity concentration (Bq/mL). Homogenisation of the ¹⁸F/¹⁸F-FDG in the phantom can be achieved by leaving an air bubble of approximately 10-20 mL within the phantom and subsequently shaking/mixing the phantom for a short time (10 min). Emission scans of the calibration phantom are then performed with the PET/CT camera using the same acquisition and processing parameters that can be used for the Subject studies. For a NEMA/IEC Image Quality Phantom: even if a correct cross-calibration is guaranteed using the above-described QC procedure, differences in SUV quantification may still occur between Sites as a result of differences in the reconstruction and data analysis methodology. In particular, differences in the final image reconstruction (i.e. following reconstruction, including all effects due to filters and pixel size settings, etc.) have, depending on the shape of the tumor, a significant effect on the SUV result for small (<5 cm diameter) tumors. It is therefore important to determine the accuracy of the SUV using a standardized ‘anthropomorphic’ phantom containing spheres (simulated tumors) of varying sizes. Phantoms such these enable to verify SUV quantification under clinically relevant conditions. The aim of the image QC procedure is firstly to determine the correctness of calibration and quantification using a non-standard phantom and secondly to measure ‘activity concentration recovery coefficients’ as a function of the sphere (tumor) size. An example of how to perform the test is therein specified, but Sites could adhere to different international and national protocol to perform the test [5-13]. In short, the procedure can be as follows: a syringe is filled with approximately 20 MBq of the ¹⁸F/¹⁸F-FDG solution and is re-measured in a calibrated activity calibrator (or the syringe is ordered from a pharmaceutical company). The ¹⁸F/¹⁸F-FDG is then introduced a 1L bottle filled with water, which results in a solution containing an exactly known activity concentration (20 kBq/ml). All the spheres can be filled with this solution. Then the background compartment can be completely filled with water. Remove 30 mL of water from the background compartment of the phantom. Add 20 MBq ¹⁸F/¹⁸F-FDG in the background compartment. Make sure all activity is removed from the syringe into the phantom, by re-flushing. Homogenisation of the ¹⁸F/¹⁸F-FDG in the phantom is achieved by leaving an air bubble of approximately 10-20 mL within the phantom and subsequently shaking/mixing the phantom for a short time (10 min). Position the phantom so that the spheres are located at the Site of the axial field of view. Emission scans of the calibration phantom are then performed with the PET/CT camera using the same acquisition and processing parameters that can be used for the Subject studies plus a 10 minutes study.

With respect to the indicated P4 Test, when the PET IS can be reported in a quantitative way or MPS does not exist on the Site, the P4 phantom is used for SQP. To verify the ability of the imaging Site to follow the CLT PET protocol two different test Subject scans can be uploaded to the dedicated CLT system Server. Subject scans can be acquired using the CLT specific PET protocol. The contact information for the Reference Physician responsible for the test Subject acquisitions can be provided to the WCL. Accompanying documentation includes the measurement of the average SUV in liver and the maximum SUV in one lesion at nuclear medicine physician's choice. The presence of the expected list of PET acquisition parameters is automatically verified after the IS upload on system.

An administrator provides the WEB infrastructure for the Core Laboratory activities by means of the system, so as to accomplish the following functionalities: Database for uploaded and stored ISs; DICOM data transfer and IS electronic form parameters consistency; Analysis of IS acquisition and reconstruction parameters; Software for the analysis of the uniform Phantom scan; Software for the analysis of the image quality Phantom scan. The analysis of the different Phantom scans can be done as follows: 1) Uniform Phantom: Volume of Interest (VoI) analysis is performed in order to determine the average volumetric concentration of activity within the phantom as measured by the PET scanner. Cross-calibration factors between the PET camera and the dose calibrator and are derived directly. The cross-calibration factor between the PET camera and dose calibrator can be equal to 1.0 (within a 10% tolerance). 2) NEMA/IEC Image Quality and P4 Phantom: the procedure is carried out closely in accordance with the ‘image quality, accuracy of attenuation and scatter corrections’ procedure described in the NEMA Standards Publication NU 2-2001. The average concentration of activity (or SUV) for the sphere is normalized to the actual concentration of activity in the spheres, which indicates the activity concentration Recovery Coefficient (RC) per sphere (i.e. the ratio of the measured and actual concentration of activity as a function of sphere size). The RC is then measured as a function of the sphere size and VoI definition. RCs that do not deviate from multi-center standard specifications by more than 10% with respect to the recommended value given in EANM guidelines are accepted. 3) Subject test: verify that test Subject average SUV in liver and maximum SUV in a lesion correspond to the values reported by the submitting Site. A nuclear medicine physician can qualitatively analyze the ISs and scores them on a 5-point scale from Bad to Good (1-5). Scores 4 and 5 can be admitted.

Upon successful completion of the Core Laboratory Data Analysis, the WCL can qualify the Site for the CLT ¹⁸F-FDG studies, in four Qualification Levels (QL), for example, such as: a) Visual: PET ISs are comparable across different sites when visual analysis is used for assessment; b) Semi-quantitative: PET ISs are comparable when Visual Analysis is used for assessment and SUV values are reliable. SUV values can be used inside the same Subject IS (e.g. comparing lesion and liver) and between different ISs of the same Subject (e.g. comparing SUV lesion of ISs acquired 1 and 2 hours after tracer injection); c) Quantitative: PET ISs are comparable when Visual Analysis is used for assessment and SUV values are reliable for different Subjects, across different Sites; and d) Resolution Recovery: PET ISs reconstructed with resolution recovery algorithm are comparable between different Sites.

With respect to site inclusion/exclusion criteria, the QP is completed when the Site has met the requirements for: Imaging Capabilities; Principal Technical Equipment; Ancillary Technical Equipment; and Image Quality. Any failure in meeting the requirements causes the Site to be excluded from the CLT until the requirements are met and the SQP is successfully completed. The system also can provide a learning process for reviewers (e.g., a “imLearning” module such as referenced in some figures herein).

With respect to clinical trial site configuration and checklist, the information about Sites listed in the following tables is essential for a successful SQP and can be certified by the Site Director/Coordinator/Contact Person. The information is grouped in different tables, according to the following scheme: Site Contact Information; Site Data Transfer Information; Imaging Questionnaire; Phantom Questionnaire; Test Subject questionnaire. The information generated by the analysis taking place in the WCL, that certifies the compliance of Imaging Sites is listed at the end, together with the list of Sites that meet/do not meet the SQP criteria. The results of the SQP are notified to the WUS, the Site Contact Person, the CRO Contact Person, the PI and the TIC. In FIG. 4D, a table 404 is shown that requires input of data on imaging equipment at the site to be qualified.

With respect to technical assessment, implementation and testing in clinical trial imaging workflow, the information collected during the clinical and imaging protocol assessment can include all that is required to properly configure system for the CLT operations. The Imaging-related CTP, handled by system, can be described by the following entities: list of NTEs; list of Notifications. Among the NTEs, two types are particularly relevant and are handled separately: the list of ISs; the list of Reports. The overall imaging CTP can then be described by the values of NTER (ISR, RR) and NR. The related information, as collected for the specific CTP, is matched to an existing database of possible NTEs and Notifications. If any of the required NTEs or Notifications is not present yet, the database is updated. The specific CTP workflow is then built by defining the sequence of NTEs, each one associated to a list of Notifications. Some examples of the possible NTEs with associated Notification (between brackets) are listed as follows: Study Upload including IS rejection (to uploader), IS availability for WCL validation (to CoreLab contact(s), and IS availability for Reviewer Panel (to Review Panel); WCL Certification including IS rejection (to uploader), IS acceptance (to Reviewer Panel); and Report Consensus Availability including within time constraint (to Site Contact(s)), time constraint missed: (to PI, Site Contact/s and Review Panel); Outliers including Single Review opposite to Combined Review (to WCL), Any difference between Single Reviews >2 steps (to WCL).

A sketch of the workflow summary can read as follows: add sketch Workflow described as a function of the ISR, NR, NTER, RR parameters. Allowed operations (i.e., actions to which the system service responds by triggering a sequence of events), can include: CRO user adds recruited Subjects to the system database; Notification to the recruiting Site; ISR# uploads trigger the corresponding NTE#; ISR# reviews trigger the corresponding NTE#. The system setup, carried out by the system Software Team (DST) takes place as a two steps process: system configuration, so as to implement the required functionality; system validation: test of the implemented functionality. Before starting the system configuration, it can be verified that all the required information was collected, as foreseen by the present document, and all the CTP related tables are filled. In particular, the availability and correctness of the following information, relevant to the implementation of the Upload Web Form (UWF) and the Report Web Form (RWF), can be verified: IS information, for all the ISs foreseen by the CTP, including: IS modalities, IS names, any other relevant IS associated observables; Report information, for all the Reports foreseen by the CTP including: Number of Reviewers, Report and Consensus Rules; Notification Trigger Event Information, as foreseen by the CTP; When required, Custom Data Analysis details; and Workflow Summary. The UWF description can include the list of ISs to be uploaded and their properties (modality, mandatory vs. optional, etc.). The UWF implements the selection of the Subject Identifier among those registered by the CRO through the system-CRO Interface. The ISs to be uploaded are identified by the ISR, labeled by the IS name and defined as optional, suggested, strongly suggested or mandatory according to the CTP. The UWF can require, when each IS upload is completed, an acknowledgement by the User (User Validation). The Report Web Form (RWF) can always display the Subject Identifier and the name(s) of the required ISs. Each Report can be identified by the RR and implements the Reporting Scale and any other data as required by the CTP. When all the required Single Reviewer Reports are available, the system Server computes the Combined Report Score (CRS). In order to do so, the following information is used: Minimum Number of Single Reports required to generate the CRS; Required Consensus Logical/Mathematical Condition(s) including Majority: obtained as average of Single Report results, Weighted majority: obtained as weighted average of Single Report results. The weight is given by the Confidence Factor, as declared by the Reviewer, and First N concordant Single Reports: obtained when the instantaneous average of results is higher than the fixed threshold; and Time Constraints, if any.

Notifications can be are triggered by well-defined events described in the CTP. The system Notification Customization is implemented by selecting each Notification from a pre-defined list, where entries are described by the required type of notification (e-mail, SMS) and the message content, and attaching its recipient list.

With respect to system validation, the system Server Configuration for the CLT can be certified by the Developers (i.e., the DST) and Users (i.e., the WUS) by running a standard set of Validation Checks. The Validation Checks can be performed by connecting from computers outside the applicable Internet URL domain on different WEB browsers, for example Internet Explorer, Safari, Firefox, Chrome, Opera, and the like.

The functionality-related validation, which can be run by the DST, can certify that all the building blocks of the CLT functions are working and properly connected according to the expected CLT workflow. Table 405 in FIG. 4E shows a checklist that can be used for this purpose. The operative system validation, run by the WUS, certifies that the system is ready for starting operations. It requires some operations to be completed, such as creating the credentials of all the CLT users, etc. As soon as the WUS and the PI agree that the system Configuration for the CLT is completed, system can be turned on for starting service.

### Part III

The Clinical Trial Operations (CTO) can start with the recruitment of the first Subject and terminate after the expected actions on the ISs of all the recruited Subjects are successfully completed. In order to start CTO: the iCLT workflow can be implemented and validated on the CLT dedicated system WEB access point; when required, the Site Qualification Process can have been successfully completed by the WCL. During CTO with system, the flow of every recruited Subject starts with the registration by the CRO in the system database. When that happens, a Notification is sent to the corresponding Site Contact Person, declaring that the IS upload for that Subject can start. Whenever a new IS is uploaded, the IS is validated (according to the CTP) with several automated checks and, when required, a visual inspection by CL. If the validation is successful, Notifications are sent to Reviewers (when required). Otherwise, a rejection Notification is sent to the Submitter, declaring the reasons of the rejection. After the Notification of IS availability to the Reviewer Panel, it is responsibility of the Reviewers to login with their credentials and download the corresponding ISs. After downloading the ISs, Reviewers are free to view and analyze them with their preferred DICOM viewer software, on their own devices. When anyone of them is ready to file a diagnosis Report, s/he can login on system with her/his credentials and fill the RWF. Upon receiving the required number of Single Reports, system generates the Combined Report Score and sends Notifications according to the CTP requirements. The upload to report cycle is repeated as many times as foreseen by the CTP, until the full imaging-related workflow for the Subject is completed. The same happens for all the Subjects recruited in the CLT, regardless of the time of recruiting, until the expected number of Subjects is reached and the CLT recruiting is completed. When also the imaging-related flow for all the Subjects is completed, the CLT Regular Operations, from the point of view of system Services, terminate.

The system Server Site Administration can be handled by the DST and the WUS. Different categories of users of the system can be given different access and action privileges on the system. A network supervisor may be designated, for example, who can be given full access to all the information and reading and editing action rights (e.g., read, add, edit, delete) for all the CLTs, and can have privileges to add Sites, Users, Subjects, Documents, Notifications, and so forth. A system User Support (WUS) role can be defined, for example, to have the rights to read all the information related to the CLT Sites; read all the information related to the CLT Subjects; upload test ISs to the system CLT Database, download ISs associated to the CLT Subjects from the system CLT Database; and/or add links and documents providing useful information for the CLT. System administrators can be defined who can include, for example, one or more of WCL users, CRO, and PI. The system administrators can be authorized, for example, to access part of the CLT-related information, but not be allowed to modify any system configuration setting or script. A system administrator can have rights, for example, to read, add, edit or delete information related to the CLT sites and/or subjects; upload (download) ISs associated to the CLT Subjects to (from) system CLT database; add links and documents providing useful information for the CLT. The rights of particular categories of system administrators may be further defined. A PI User, for example, may have full read access to CLT specific information without adding/editing rights. A CRO User rights may be restricted to a specific CLT and include adding/editing actions of Subjects. WCL Users may be able to read and edit information and ISs associated to the Sites SQP from the CLT database. Other CLT system users can include one or more of Submitters, Reviewers, and Site Medical Doctors. A Submitter attribute, for example, can only allow the use of the UWF to upload new ISs, associating them to the corresponding Subjects. A Reviewer attribute, for example, can allow the download of ISs and the submission of Reports via the RWF. A Site Medical Doctor, for example, can have the rights to read and add information for all the Subjects recruited by her/his Site.

All the data stored during CLT can be considered as electronic format data and can be stored accordingly. Storage and archiving of ISs and data can be done on a central server Medical Device (MD) certified HA class (new requirement as of 1 Jan. 2010). Images can fully meet CTP specifications, are secure and compliant with 21-CFR part 11, ISO 9001 and ISO 13485 Medical Device standards. Periodical data report can be sent to the PI including the standard Data Analysis that is updated continuously in system, such as number of Subjects (relevance); reviewer agreement level (i vs. j, full panel) and reviewer Precision (Se, Sp, Ac, PPV, NPV, etc.) and Accuracy (Cohen, Fleiss, Krippendorf). Custom Data Analysis also can be reported such as Statistical indices: to be determined at least in part by the PI, agreed between the PI and a system medical team, on request of PI, and Image analysis: optional, to be agreed between the PI and system medical team, on request of PI.

With respect to clinical trial quality control and auditing during recruiting, the general definition of an audit can be “an evaluation of a person, organization, system, process, enterprise, project or product”. Audits are performed to provide an assessment of a system's internal control. Audit is commissioned by the Sponsor and usually carried out by the CRO. CLTs can undergo 2 types of audits, for example: Regular Check Audits: The aim of a regular check audit is to understand the current state of the CLT in order to increase its success; Regulatory Audits: The aim of a regulatory audit is to verify that a project is compliant with regulations and standards. In case of a CLT, regulations are all the actions that are specifically described in a CLT protocol. Best practices of auditing describe that, the regulatory audit can be accurate, objective, and independent while providing oversight and assurance to the organization. The purpose of the audit, which is independent of and separate from routine monitoring or quality control functions, is to evaluate trial conduct and compliance with the protocol, SOPs, GCP, and the applicable regulatory requirements.

With respect to noncompliance, noncompliance with the protocol, SOPs, GCP, and/or applicable regulatory requirement(s) by an investigator/institution, or by member(s) of the sponsor's staff can be required to lead to prompt action by the sponsor to secure compliance. If the monitoring and/or auditing identifies serious and/or persistent noncompliance on the part of an investigator/institution, the sponsor should terminate the investigator's/institution's participation in the trial. When an investigator's/institution's participation is terminated because of noncompliance, the sponsor can promptly notify the regulatory authority(ies). In a CLT, the non-compliance is also defined Protocol Violation (PV). Regulatory audits cam be planned randomly or “on demand”. On demand audits are regulated by a set of rules, which are planned, whenever possible, a priori before CLT onset. With respect to quality audits performed by the system, the standardization or PET scanning procedures is becoming essential in multicenter CLTs. Fluctuations in image results are common; they can be somehow handled when using visual assessment. However, when PET scans are used as a biomarker, procedures of Quality Assessment, Quality Control and Site Auditing are essential. The system has been conceived to perform, for example, a set of periodical auditing procedures during the CLT progress, which can be carried on: at the PET Site level; at the Reviewer level; at the PI level. With this system, it is possible to retrieve an information set related to the injected activity, the Subject body and height, the time of injection, the time of PET scanning, the fasting glucose level of the Subject, the image reconstruction algorithm parameters. With respect to scan parameters, these parameters are weighted for error and the frequency of deviation from the expected/allowed range is automatically recorded by system. PET scans can be then classified in three categories, according to a set of rules defined and agreed between the PI and the DMT: depending on the level of compliance to these rules, PET Sites Auditing is (a): non-necessary; (b) necessary without decision; (c) necessary with decision.

With respect to site compliance, in view of data input coming from the CRO, the time interval between the Subject enrolment and the PET scan execution can be monitored automatically by system. This is useful both for action-triggering PET scan, but also for non-triggering PET scans. As a result, PET Sites can generate an “Imaging enrolment curve” very similar to the one obtained by the CRO as “Subject enrolment curve”. The first can be matched with the latter to give an assessment of Site compliance. The Reviewer's performance can be automatically checked by system as binary concordance rate (expressed as the Cohen's k or Fleiss' k coefficient) and overall concordance rate (Krippendorf's alpha coefficient). A set of rules can be agreed upfront with the CLT PI: depending on the performance, which is monitored, a single Reviewer can be re-trained or substituted in the Review panel. When imaging is used to reach a definite CLT endpoint, the size of the sample of Subjects to be enrolled is usually planned on a definite hypothesis of potency of the proposed endpoint in determining the results of the CLT. Starting from the ISs dataset (with or without review), the system can calculate, in real time, the statistical significance with respect to the hypothesis made to define the sample size of Subjects to be enrolled. Therefore, when the expected goal is met the recruiting can be closed. If, on the other hand, a negative result is obtained, the CLT can be closed, so as to avoid spending further time on a wrong hypothesis. Periodic reports on the CLT partial results and their statistical significance can be sent to the PI. With respect to real time auditing on ISs, the definition of requirements and constraints on several parameters associated to the ISs is part of the CTP. Presently, a typical iCLT does not systematically verify the compliance of ISs with the requirements: the task is done on the subsample of the ISs and it is delayed in time. The system provides by design an environment that allows an implementation of Real-Time dynamical Auditing on each and every one IS that is part of the CTP. ISs are collected on the system Server and, before being made available to the Panel of Reviewers, can undergo a validation stage, called system Traffic Light, which verifies the IS compliance to all the requirements and assign a Green, Orange or Red Light. The IS Real-Time Auditing can be implemented by a dedicated software, which scans the DICOM data structure, verifies its compliance to the standard DICOM, verifies all the mandatory requirements, as described in the dedicated tables (e.g., compliance of the anonymization, presence of the list of mandatory DICOM tags, checks on the accepted values/intervals of the specified DICOM tags). The procedure terminates by accepting the IS (Green light), requesting further information (Orange light) or rejecting (Red light) the uploaded ISs. When required, a Notification of the successful completion can be sent to the relevant system Users. The IS Real-Time Auditing functionality can be classified as a set of checks that verify the IS compliance from three different points of view.

With respect to DICOM compliance, when an IS is uploaded system automatically checks the DICOM headers and rewrites the IS headers in DICOM 3.0 standard so as to permit the largest interoperability among IS DICOM viewers. With respect to HIPAA compliance, it can be the assigned responsibility of the local Site to anonymize ISs before transmission. The system, nonetheless, can perform a validation check of the Health Insurance Portability and Accountability Act (HIPAA) compliance, clearing or properly setting the DICOM tags in order to avoid the diffusion of privacy data. With respect to Imaging Protocol Compliance, whenever an IS is uploaded and the DICOM and HIPAA compliance verified, the system can verify the so-called CTP compliance. In other words, it retrieves the list of CTP-specific requirements (e.g., PET uptake time in the 50-70 minute range) and verifies that the information stored in the IS DICOM header is compliant to the CTP. When a non-compliance is found, depending on the severity (as declared in the CTP), system: accepts the IS, with a notification about the missing or non-compliant information; rejects the IS and notifies the reason (missing or non-compliant information) to the Site and the PI. The system also can be configured so as to parametrize all the CLT-specific information and insert a custom module in the IS automated analysis workflow.

With respect to surveillance regulatory audits, surveillance regulatory audits can be a typical task of an iCRO. In theory, any Protocol Violation (PV) or Standard Deviation (SD) can trigger an audit. In iCLTs regulatory audits can be planned. They can be performed in a random fashion or “on demand”. As stated, the system can perform a real-time auditing process at various levels: the Site level, the Reviewer level, the IS level and periodical reports on protocol adherence are generated and distributed to the CRO and the PI. Nonetheless, additional audits can be planned either on demand or randomly. The number or audits and the decision to be made based on the audit results are agreed with a signed consent between the PI and the CRO before starting CLT operations. PET Sites can also sign their consent to regulars and regulatory audits as well as their acceptance on Auditor's decision.

### Part IV

With respect to Post CLT Operations, after the execution of the last imaging study of the last recruited Subject, data can be kept online for a time interval agreed upon by the originators of the CLT or in compliance with any regulatory requirements in this respect. The CLT principal investigator may control the property of the CLT data and can delegate the DMT to perform a number of data analysis procedures on the CLT results. The purpose and list of Data analysis tasks can be detailed before the study onset. All the procedures related to data analysis, interpretation, editing that are to be utilized by the PI to present the results of the CLT to the scientific community can be defined before the study onset and agreed with a signed consent. The duration of Subject follow-up can also be described in the CTP in a point-by-point fashion. According to ICH-GCP CLT data results can be stored and made accessible for inspection by regulatory authority for a specific time period, such as for at least 5 years after the CLT closing. A system data archive can provide a database in this respect, although other options may be used in this respect. Besides CLTs, many other medical applications can exploit the system functionality. Among them, there includes the training of specialists in reporting ISs, which can be thought of as a standalone task and/or as a support to CLTs. A system module (e.g., identified as imLearning in some figures herein) that provides the possibility to access a dataset of ISs, download and review them, then upload the reports which are compared to an available Gold Standard and generate a score for the reviewer performance.

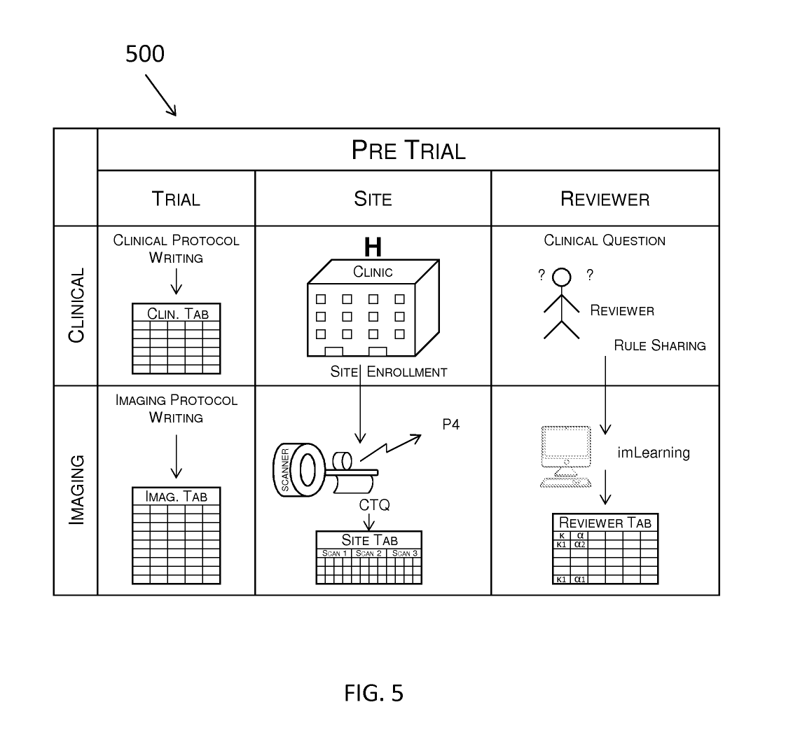

In FIG. 5, a pre-clinical trial workflow 500 of an image-based study is shown in chart form. In this example, each clinical trial is imaging based, and clinical and imaging protocols are written for qualifying imaging operations at sites and auditing data submitters and reviewers. Screen tabs that can appear on an administrator interface when accessed to the system for these developed protocols, are illustrated as “CLIN TAB,” “IMAG TAB,” “SITE TAB” (also, referred to herein as “SCAN TAB,” and “Reviewer TAB.” A procedure for clinical trial qualification is set for each clinical trial depending on its complexity. For reviewers, clinical questions for diagnosis evaluation and optional imaging learning/training is determined.

Review rules and Cohen's kappa, Fleiss' kappa, and Krippendorf's alpha coefficient-based algorithms for assessing reviewer concordance can be established in the system. As known, Cohen's kappa is a measurement of concordance or agreement between two raters or methods of measurement. The method can be applied to data that are not normally distributed, even binary (no/yes), and can be well suited to a close ended ordinal scale, such as the 5 point Likert scale. Fleiss kappa can be a statistical measure for assessing the reliability of agreement between a fixed number of raters when assigning categorical ratings to a number of items or classifying items. The Fleiss' kappa measure can calculate the degree of agreement in classification over that which would be expected by chance. Fleiss' kappa can be used with binary or nominal-scale ratings. Krippendorf's alpha coefficient is a statistical measure of the agreement achieved when coding a set of units of analysis in terms of the values of a variable, and is used in content analysis where units are categorized by trained raters. Krippendorf's alpha coefficient can generalize several known statistics, often called measures of inter-coder agreement, inter-rater reliability and the like.

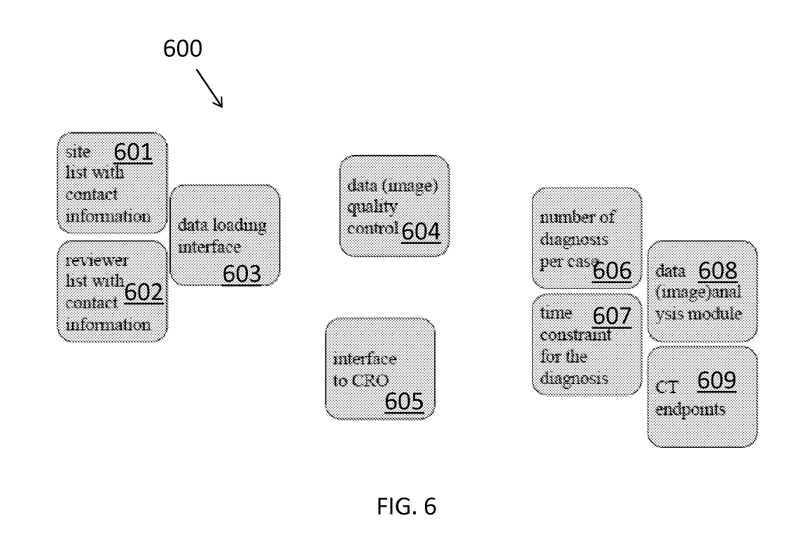

FIG. 6 shows a schematic 600 of a suite of building blocks or modules 601-609 that can be offered by the system to a clinical trial principal investigator, or administrator working in conjunction with the investigator, which modules can be selected during preclinical trial development of protocols for the trial. These building blocks are illustrative and not exhaustive.

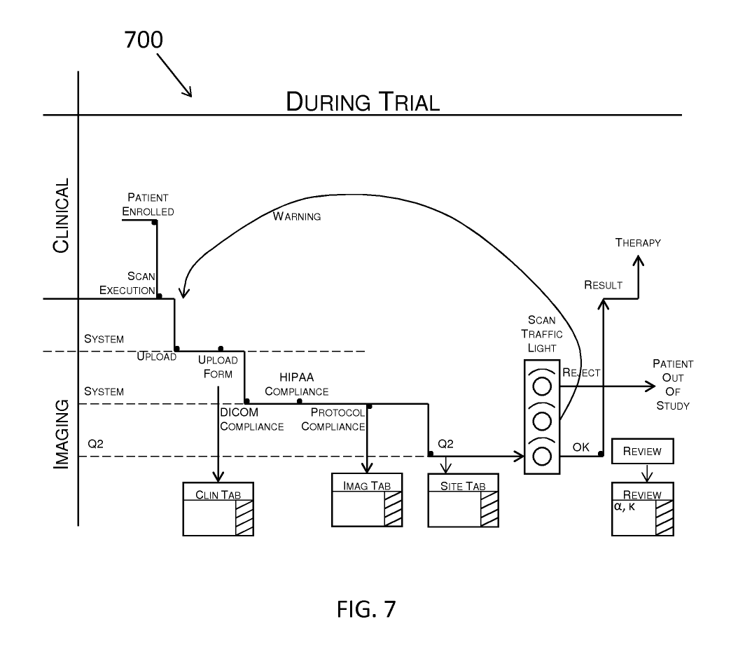

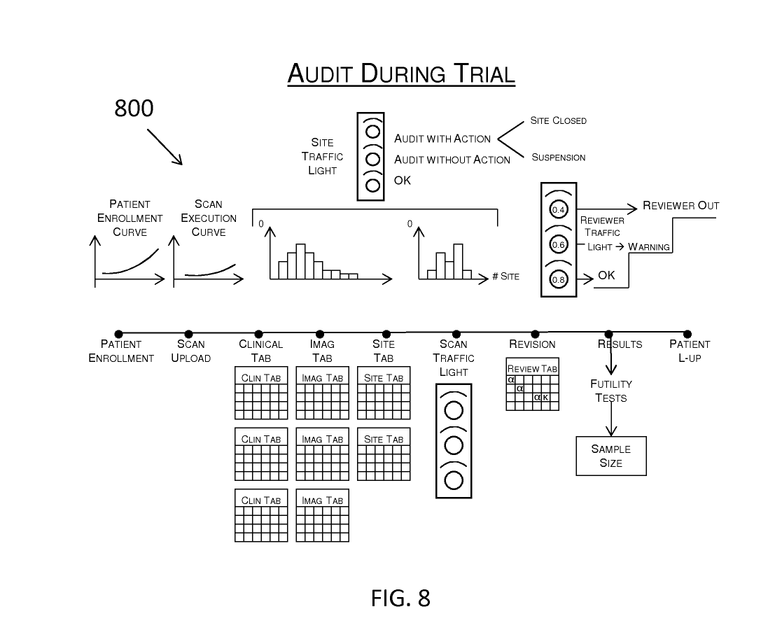

FIG. 7 shows a schematic of workflow 700 during a clinical trial. As shown, a subject is enrolled in the system. The subject imaging study (IS) is performed and shortly afterwards uploaded to the system. With respect to the indicated Clinical Table (Clin Tab) population, local investigators, when uploading ISs, can fill a form containing information related to the clinical management of the subjects. The information requested must be stated in the clinical trial protocol. Once the form is submitted, the system automatically can populate the Clinical Table. For DICOM compliance, when an IS is uploaded, the system can automatically check the DICOM and the IS headers can be written in DICOM 3.0 standard, for example, to permit the largest interoperability among IS viewers. For HIPAA compliance, when an IS is uploaded, the system automatically can verify the HIPAA compliance and the IS headers are written in HIPAA standard to avoid the diffusion of privacy data. With respect to imaging protocol compliance, when an IS is uploaded and the DICOM and HIPAA compliance are verified, the system can populate the Imaging Table (IMAG TAB) retrieving data from the reading of the DICOM header. When an IS is uploaded, the system can populate the Scanner or Scan Table (e.g., see FIG. 8 and related discussion infra). Firstly, the system can retrieve from the core laboratory database the Name and ID of the scanner that acquired the IS. Then the system can check whether the scanner underwent site qualification process (SQP). If so, the Scanner Table is populated with data from the Site Table (SITE TAB). Otherwise the IS is rejected (and the Site can be notified). With respect to automatic pattern recognition, when an IS is uploaded, the system can run a pattern recognition algorithm and consequently can run checks on semi-quantitative indices according to the clinical trial protocol requirements. A Scan (IS) traffic light can be provided as shown. When the scan (IS) table is completely filled, being populated by Clinical Table, Image Table and Scanner table, the scan traffic light check is launched. If all the parameters of the IS comply to the imaging CTP (e.g., if the uptake time in a PET scan has been between 50 and 70 minutes, etc.), the scan is cleared for review. A warning is sent when the parameters are outside the warning limit as defined in the clinical trial protocol workflow or some parameters are missing. In this case a pop-up can appear to the uploader asking to provide the missing information. The IS table can be populated with this new information and the Scan Traffic Light launched again. The IS is rejected if some parameters are outside the CLT acceptance range, as defined in the clinical trial protocol.

FIG. 8 shows an audit workflow 800 that can be applied during a clinical trial of an example of the present invention. With respect to auditing subject enrolment, the clinical trial when the local clinical investigator inserts his/her data into the combined report form (CRF). The system can calculate automatically the subject enrolment curve, which represents the number of subjects enrolled by the clinical trial in the unit of time. The system can calculate the subject enrolment curve for the whole clinical trial dataset and for each participating Site. If the subject enrolment rate is outside the planned range, set by the clinical trial statistical requirements, a warning can be sent to the primary investigator. When a predefined number of warnings to a Site (e.g., 3 or other number) is reached, an audit is planned. With respect to auditing imaging study (IS) enrolment, a new IS can be enrolled for a subject when the local imaging investigator inserts the IS related images and data into the system. The system can calculate automatically the IS enrolment curve, which represents the number of IS per subject enrolled by the clinical trial. The system can calculate the IS enrolment rate for the whole clinical trial and for each participating site. If the IS enrolment rate is not compatible with the expected range, a warning can be sent to the principal investigator. When a predefined number of warnings to a site (e.g., 3 or other value) is reached, an audit is planned. With respect to auditing table population, when a new IS is uploaded, the system can populate the Clinical Table, the Imaging Table and the Site Table. The system can automatically calculate all parameters frequency and 1st and 2nd order statistics for the whole clinical trial and for each site. When a parameter is, e.g., 3 times in the tail of the distribution (e.g., 2 sigma) study, a warning can be sent to the local imaging investigator at the site and to the principal investigator of the clinical trial. After a specific number of warnings, e.g. 3 warnings, to a center, an audit can be planned. With respect to the IS traffic light shown in the figure, the IS traffic light verifies that the uploaded IS is protocol compliant. During a clinical trial, the system can automatically calculate the number of warnings and the IS rejection rate (global and per site). When a red signal or three consecutive orange signals are addressed to the same site, for example, an audit can be planned. With respect to review of the imaging data, the panel of experts can review the ISs after they have been accepted by the IS traffic light. The review by them can be done according the rules established by the clinical trial protocol. When a reviewer does not insert its review for 3 consecutive ISs, or other preselected threshold value, or the integral review rate falls below a pre-defined threshold (e.g., 90% or other value), a warning can be sent to the reviewer and the principal investigator. With respect to IS Reports, when an IS Report is available, it can be stored into the system. The rate of positive and negative Reports are updated in real time and compared to those expected in the statistics of the study. A warning can be sent to the primary investigator if they are statistically not compatible (e.g., p<0.10). As used herein, a system audit can be an ensemble of actions addressed to the participating site to verify the clinical trial compliance. There can be, for example, three (3) levels of audit action, comprising Level 0: communication to the Site of the reason for warning; Level 1: audit to the Site without further action; and Level 2: audit to the Site with temporary suspension. The Audit result can trigger three possible outcomes, which can be No action; Site Injunction; and Site closing.

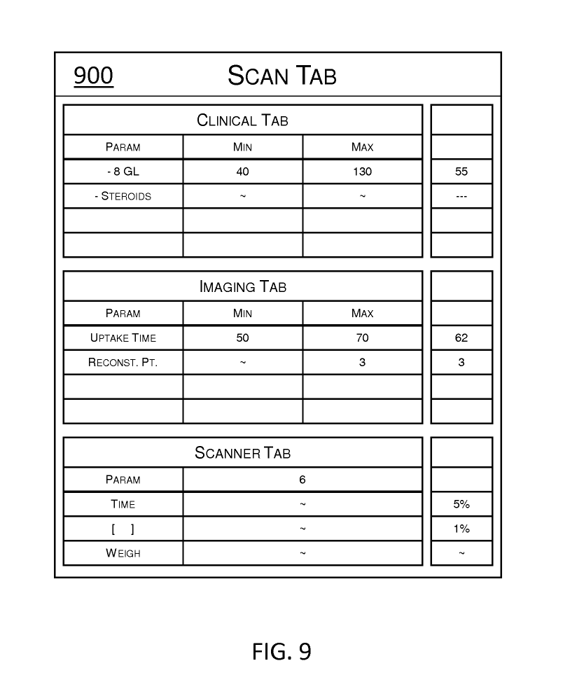

FIG. 9 shows a multiparametric table 900 than can be used in the system of the present invention. The IS Table contains all the information on the IS sent to Reviewers. It is composed of three different tables described hereafter. The IS Table is filled dynamically at the time of IS upload with the actual values of all the requested parameters for that IS. Dynamic automated checks are carried out on these values. The Clinical Table (CLINICAL TAB) is a static table that can be filled at the moment of clinical trial protocol approval. It contains all and only the clinical information that is required by the panel of Reviewers to generate the IS Report. Examples of this kind of information are the use of steroids prior to IS or the description of an inflammatory state present at scan time (i.e. tonsillitis or other site of infections). Other examples include pathology of the Subject not connected to the disease object of the study (e.g. fracture and bone heeling), evidence of recent biopsy or surgical intervention or blood hemato-chemistry (blood glucose level, CRP, etc.). When appropriate, the Clinical Table indicates what is the range of values permitted for each parameter. The Image Table is a static table that also can be filled at the moment of clinical trial protocol approval. It can contain all and only the requirements on the image acquisition and reconstruction (e.g. reconstruction algorithm, uptake time, injected activity, mAs and kV, etc.). The Site Table (SCANNER TAB) is a static table that can be filled at the moment of the site qualification process (SQP). The parameters of the Site Table, can be common to all the ISs coming from the scanner with whom images have been acquired. Using the error information, an error can be associated to the unit (e.g. BQML, standardized uptake value (SUV), or HU) in which the image is stored.

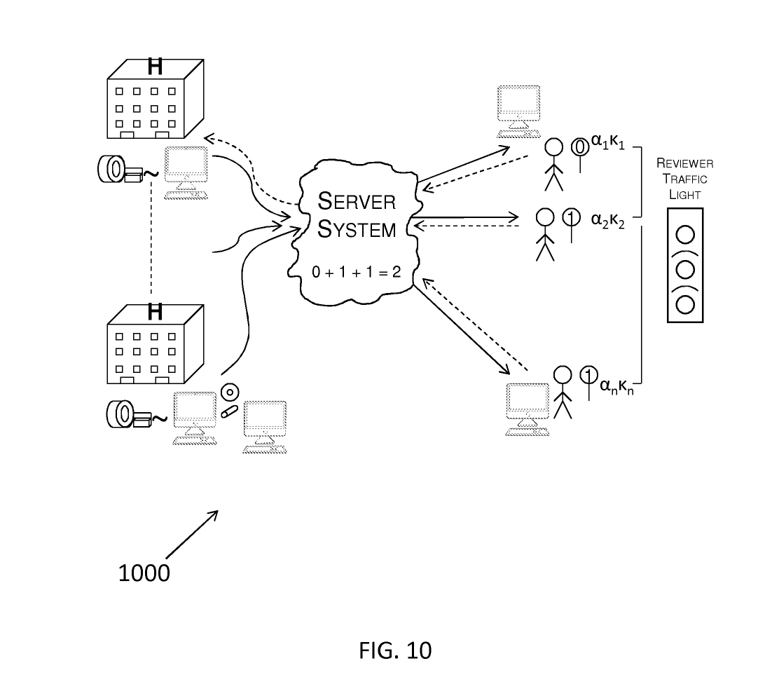

Referring to FIG. 10, a reviewer workflow 1000 is shown with respect to IS Distribution. An IS can be uploaded to the system and, when the traffic light is green, made available to reviewers for download. For the IS Review, the ISs can be reviewed by the panel of experts following the rules defined at clinical trial protocol onset and written in the clinical trial protocol. IS finding description and conclusions can be filled onto system in a compact way. Single IS Reports (e.g. IS positive or negative or more complex pattern like scores, such as from 1 to 5), for example, can be assigned by Reviewers together with a level of confidence ranging from 1 to 5 (1 being not at all confident and 5 being absolutely confident). With respect to Reviewers' Concordance Rate, once an IS has been reviewed, the system can automatically calculate the concordance rate among reviewers, such as by using the Krippendorf's alpha coefficient as a metric. With respect to the Reviewers' Traffic Light, the Reviewers' Traffic Light is always active in this example during the clinical trial. When the Reviewer Concordance Rate falls below a pre-defined acceptance threshold (e.g. 0.75), a warning can be sent to the reviewers and the principal investigator. Reports generated by reviewers below threshold, for example, can be set to stand-by and are not considered for review until the concordance rate is higher than 0.75 or another selected value. If the Concordance Rate falls below a pre-defined exclusion threshold (e.g., 0.5), the reviewer can be excluded from further reporting or probationed subject to online retraining using a training module that can be included and accessible on the system.

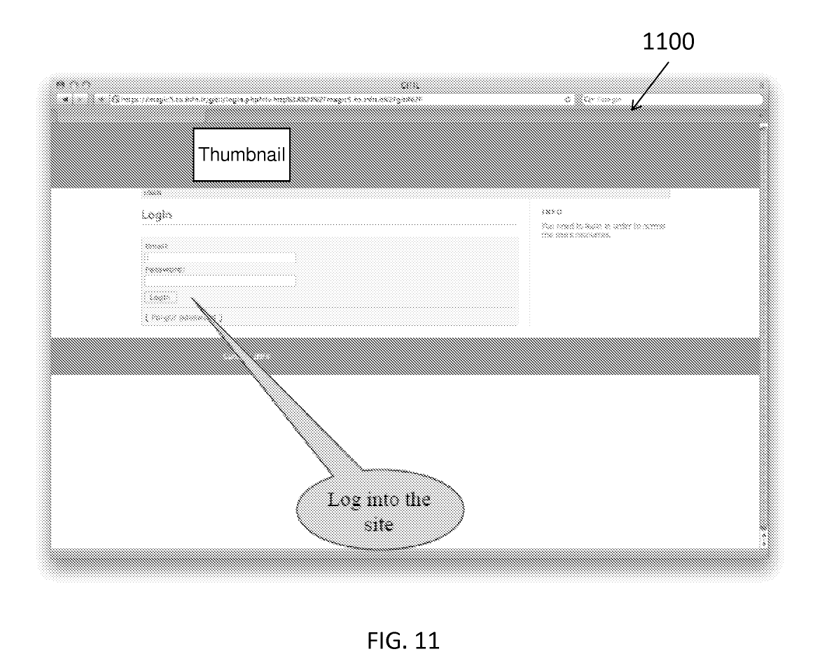

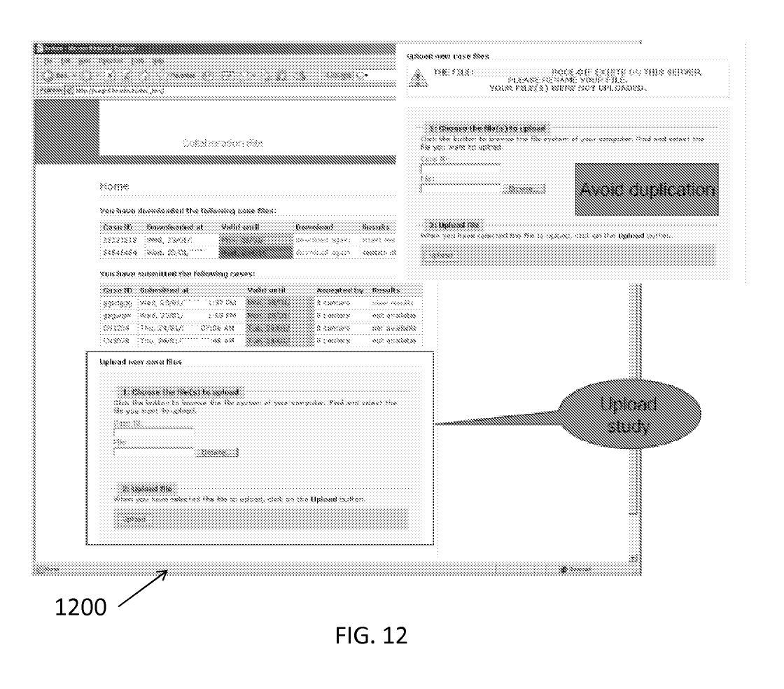

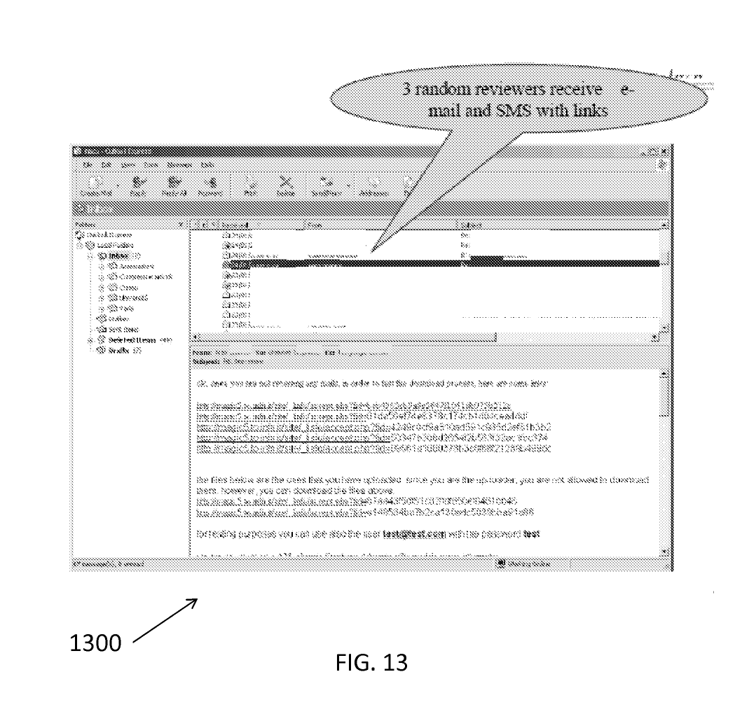

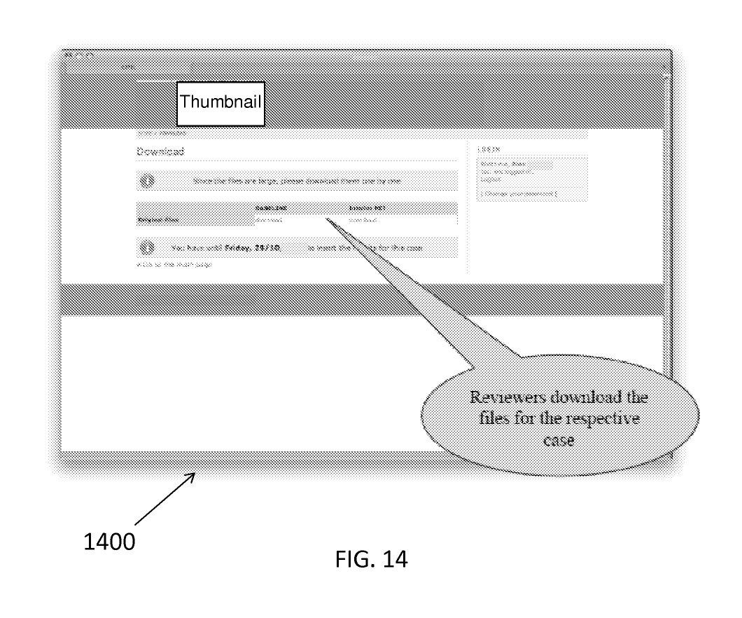

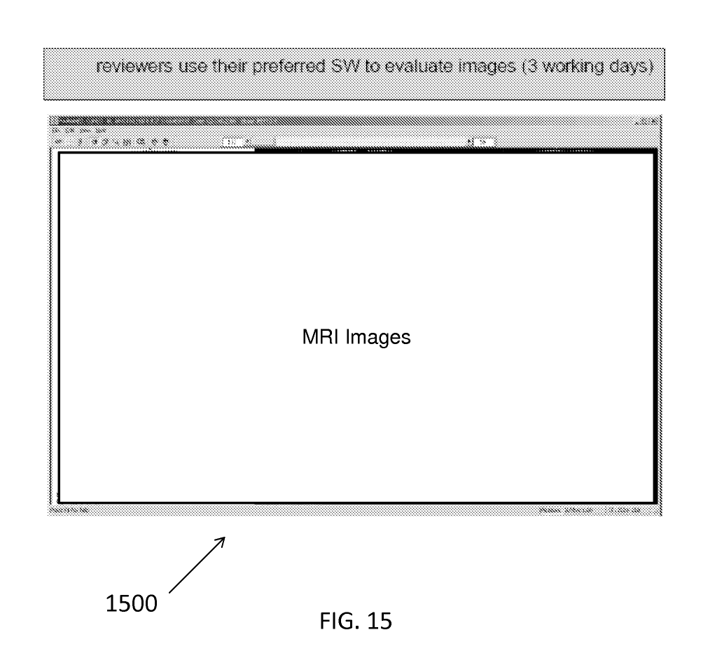

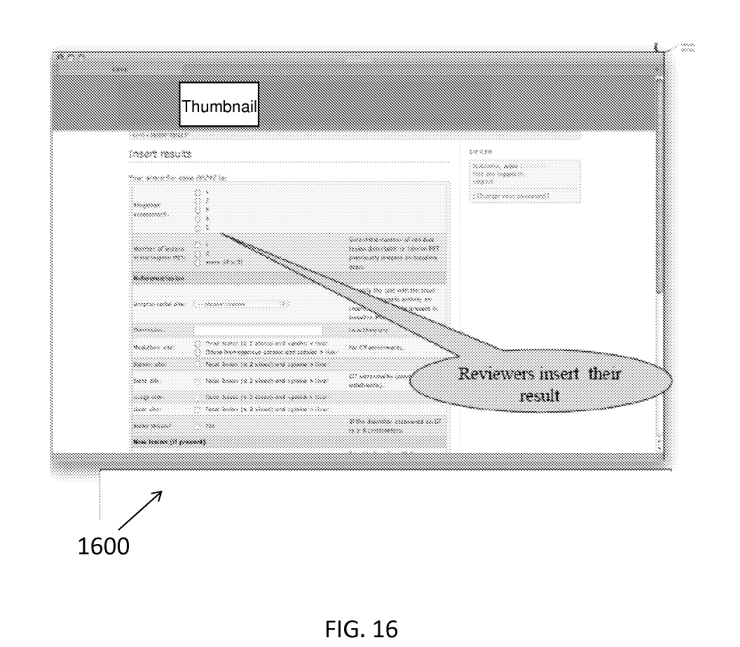

FIGS. 11-16 show exemplary screen shots of interfaces that can provided on a remote device in accessing the system of the present application. FIG. 11 shows an exemplary screen shot 1100 of an interface that can provided on a remote device for logging into the system via a website. FIG. 12 shows an exemplary screen shot 1200 of an interface that can provided on a remote device for uploading imaging data of an imaging study to the server of the system. FIG. 13 shows an exemplary screen shot 1300 of an interface that can provided on a remote device for notifying reviewers with links to a compliant submitted imaging study for review. FIG. 14 shows an exemplary screen shot 1400 of an interface that can provided on a remote device for a review to download an image study. FIG. 15 shows an exemplary screen shot 1500 of an interface that can provided on a remote device of a reviewer using a reviewer-selected image viewing software to evaluate the images within a prescribed timeframe. FIG. 16 shows an exemplary screen shot of an interface that can provided on a remote device for reviewer entry of evaluation answers into report form of the system.

The various steps and methods disclosed herein have been provided for purposes of illustration and are not intended as limitations of the present invention. The methods can be performed for one or more different participating sites and/or users as the case may be. Further, communications among the various entities described herein can be secured using any of a variety of different encryption mechanisms or other secured communications techniques. The present invention provides for improved and more detailed monitoring of clinical research data. Data collection can be monitored in real time as information regarding the identity of the investigator that entered subject data and when can be preserved. As any transaction of the system can be preserved along with a corresponding audit trail, the present invention makes significantly more process information available than conventional paper-based clinical study systems. On-site monitoring of clinical data can be greatly reduced. Data, an investigator site's performance, and/or a reviewer's performance can receive more scrutiny using embodiments of the present invention. This increased level of monitoring requires less human effort and can be automated to a great extent. Accordingly, investigator sites can be audited for cause if necessary as such cause can be readily detected by the system, for example through an automated reporting function or detection of another metric or measurement which can be applied to the data as collected. Clinical trial monitors can view data as the data is accumulated and further electronically query investigator sites as to the accuracy of the data. The monitors can electronically ask the investigator site to confirm, correct, or acknowledge that data items may be incorrect.

It should be appreciated that while the inventive arrangements disclosed herein have been described with reference to managing and administering a single clinical trial, the present invention can be used to manage and administer more than one clinical trial simultaneously. That is, the clinical study system can be configured such that each clinical trial has its own set of interface pages and/or data processing components. For example, multiple instantiations of the clinical study system disclosed herein can be configured or the components of the system can be configured to directly manage and administer multiple clinical trials.

The present invention can be realized in hardware, software, or a combination of hardware and software. The present invention can also be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein. The present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

The present invention also relates to at least one non-transitory computer-readable storage medium encoded with a plurality of computer-executable instructions that, when executed by at least one processor, performs a method described herein.

The present invention includes the following aspects/embodiments/features in any order and/or in any combination:

1. The present invention relates to a method of managing a clinical trial, comprising:
a) verifying compliance with pre-determined data collection protocols in real time of at least one type of medical data collected on a clinical trial patient from at least one of a plurality of peripheral clinical trial centers participating in the clinical trial;
b) sending, upon verifying compliance in a), electronic notifications to a plurality of reviewers of the availability of the medical data for review by the reviewers;
c) collecting reports submitted by the reviewers via an electronic form, wherein the review reports comprise answers of the reviewers to a common predetermined set of diagnosis questions about the medical data;
d) evaluating the answers in the review reports, for concordance; and
e) transmitting at least one electronic notification pertaining to a result obtained from the evaluating,
wherein at least one of the verifying, sending, collecting, evaluating, and transmitting is performed using at least one processor.
2. The method of any preceding or following embodiment/feature/aspect, wherein the verifying comprises at least one of checking for compliance with a pre-selected digital communication requirement, checking for patient file anonymity compliance, checking for compliance with at least one pre-selected diagnosis equipment and/or operational requirement, and checking for compliance with a time-frame reporting requirement for reporting acquired medical data for the clinical trial.
3. The method of any preceding or following embodiment/feature/aspect, further comprising operating at least one computer processor to display at least one user interface on a display of a remote data entry device that is configured to provide a user access to at least one clinical trial function via the at least one user interface.
4. The method of any preceding or following embodiment/feature/aspect, wherein the at least one clinical trial function includes medical data processing, electronic transmission of medical data, patient data entry, medication dispensation/treatment data entry, clinical endpoint adjudication, and training module access.
5. The method of any preceding or following embodiment/feature/aspect, further comprising:
prompting the user for identifying information;
receiving identifying information from the user; and
configuring the user interface, based at least in part, on the identifying information.
6. The method of any preceding or following embodiment/feature/aspect, wherein the medical data comprises imaging data.
7. The method of any preceding or following embodiment/feature/aspect, wherein the medical data comprises a positron emission tomography (PET) image, a magnetic resonance image (MRI), a computer axial tomography scan (CAT Scan) image, or a sonogram.
8. The method of any preceding or following embodiment/feature/aspect, wherein the sending of electronic notifications comprises e-mailing, text messaging, instant messaging, automated voice messaging, or any combinations thereof.
9. The method of any preceding or following embodiment/feature/aspect, wherein the transmitting of electronic notifications comprises e-mailing, text messaging, instant messaging, automated voice messaging, or any combinations thereof.
10. The method of any preceding or following embodiment/feature/aspect, wherein the transmitting of the at least one electronic notification on a result obtained from the evaluating comprises e-mailing or text messaging to at least one of an investigator or an administrator of the clinical trial.
11. The method of any preceding or following embodiment/feature/aspect, wherein the at least one remote computer is a device having a web browser, a microprocessor, a memory, and a display comprising a user interface.
12. The method of any preceding or following embodiment/feature/aspect, wherein the processor comprises a memory, the transmitting comprises electronically transmitting the electronic notification, and the method further comprises storing the electronic notification in the memory.
13. The present invention relates to a computerized method for managing a clinical trial, comprising:
a) accessing a gateway to a server computer on a computer system via the Internet from at least one remote client computer having a web browser, wherein the server computer comprises a processor operable to run a program loadable on the processor for managing workflow of a clinical trial, wherein the clinical trial involves a plurality of physically separate sites from which imaging study images obtained on patients in the clinical trial are to be generated for image and diagnosis exchange;
b) inputting details at the server computer to configure a workflow program for a clinical trial to be managed on the computer;
c) designating users for the workflow program under different categories of users, each category of user being granted different respective categories of access to the workflow program;
d) populating patient lists for the workflow program;
e) calibrating image quality control for the clinical trial to be managed using the workflow program;
f) configuring QA (Quality Assurance before study onset) and QC (Quality Control during clinical trial) requirements related to calibrating image quality in every single site participating to the clinical trial;
g) uploading an imaging study by logging into the gateway to the server computer;
h) auditing an imaging study uploaded to the workflow program in real time, to determine a successful imaging study submission, wherein the auditing comprises at least one procedure of checking digital communication in medicine compliance, checking patient file anonymity, checking protocol compliance, and checking time-frame of reporting;
i) sending, upon determining a successful imaging study submission in step h), notifications to designated image reviewers, designated laboratory users, contract research organization users, a principal investigator, a workflow administrator, or any combinations thereof;
j) logging into the gateway to the server computer, by each of the notified image reviewers, via the Internet;
k) downloading at least one respective imaging study image by each of the notified image reviewers, onto a respective remote client computer;
l) reviewing, by each of the notified reviewers, the at least one downloaded image using a non-specific image viewing software selected by the respective reviewer;
m) inputting, by each of the notified image reviewers, responses into a report form having a preselected question-and-answer format, which is accessed using the workflow program, for data entry capture using a remote client computer having a web browser;
n) evaluating the answers in the report forms of the notified image reviewers for concordance;
o) evaluating a consensus result of the report forms according to rules specified by the clinical trial protocol; and
p) transmitting at least one electronic notification pertaining to the consensus result obtained from the evaluating, to at least one of an investigator or an administrator of the clinical trial.
14. The method of any preceding or following embodiment/feature/aspect, wherein the server computer comprises a web server accessed at a URL address.
15. The method of any preceding or following embodiment/feature/aspect, wherein the at least one remote client computer is a laptop computer, a desktop computer, a tablet computer, or a smartphone.
16. The method of any preceding or following embodiment/feature/aspect, wherein information resulting from at least one of steps b), c), and d) is stored on the server computer in the form of a software template.
17. The method of any preceding or following embodiment/feature/aspect, wherein the auditing further comprises prompting a submitter to provide missing data, and reviewing missing data supplied in response, for compliance.
18. The method of any preceding or following embodiment/feature/aspect, wherein non-compliant imaging study images identified in the auditing are rejected for review.
19. The method of any preceding or following embodiment/feature/aspect, wherein the auditing comprises triggering auditing sessions on non-compliant sites.
20. The method of any preceding or following embodiment/feature/aspect, wherein the sending of electronic notifications comprises at least one of e-mailing and short message service (SMS) transmitting.
21. The method of any preceding or following embodiment/feature/aspect, wherein the evaluating the answers in the report forms comprises continuous monitoring of an agreement level for one or more of the notified image reviewers.
22. The method of any preceding or following embodiment/feature/aspect, wherein the evaluating the answers in the report forms comprises identifying unexpected disagreements among the notified image reviewers and transmitting an electronic notification pertaining thereto.
23. The method of any preceding or following embodiment/feature/aspect, wherein the evaluating the answers in the report forms comprises automatically checking the answers as at least one of a binary concordance rate and an overall concordance rate, and re-training or substituting a reviewer depending on monitored performance based on a set of pre-selected rules.
24. The method of any preceding or following embodiment/feature/aspect, wherein the evaluating the answers in the report forms comprises using an algorithm incorporating at least one agreement coefficient selected from Cohen's kappa coefficient, Fleiss' kappa coefficient, and Krippendorf's alpha coefficient.
25. The method of any preceding or following embodiment/feature/aspect, wherein the evaluating the answers in the report forms comprises identifying any unexpected disagreement of one of the reviewers with one or more other of the reviewers and triggering at least one auditing session on a non-compliant reviewer.
26. The method of any preceding or following embodiment/feature/aspect, further comprising computing clinical testing site non-compliance, labelling a non-compliant imaging study, and sending a notification to a principal investigator.
27. The method of any preceding or following embodiment/feature/aspect, wherein information gathered during the method is available to a clinical trial principal investigator, and the method further comprises sending periodic reports to a principal investigator, each periodic report comprising an average number of patients per site, an average patient clinical trial rate, a site compliance rate, reviewer panel concordance information, a rate of outliers in the reports, and an average report confidence level.
28. The present invention relates to a clinical trial management system, comprising:
a server computer comprising at least one processor;
at least one remote client computer having a display and a web browser and which can access the server computer via the Internet,
wherein the at least one processor is operable to generate at least one user interface on a display of a remote data entry device configured to provide a user access to at least one clinical trial function via the at least one user interface, the at least one processor is operable to run a program loadable on the server computer for managing workflow of a clinical trial that comprises a plurality of physically separate sites from which medical data obtained on patients in the clinical trial are generated for data and diagnosis exchange, and the at least one processor is operable to run the program for automatically: a) verifying compliance with pre-determined data collection protocols in real time of at least one type of medical data collected on a clinical trial patient from at least one of a plurality of peripheral clinical trial centers participating in the clinical trial; b) sending, upon verifying compliance in a), electronic notifications to a plurality of reviewers of the availability of the medical data for review by the reviewers; c) collecting reports of the reviewers based on an analysis of the medical data by the reviewers, the reports comprising answers to a common predetermined set of diagnosis questions about the medical data; d) evaluating the answers for concordance; e) evaluating a consensus according to the rules defined in the clinical trial protocol; and f) transmitting at least one electronic notification pertaining to the consensus result obtained from the evaluating.

The present invention can include any combination of these various features or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention can be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method of managing a clinical trial, comprising:
a) verifying compliance with pre-determined data collection protocols in real time of at least one type of medical data collected on a clinical trial patient from at least one of a plurality of peripheral clinical trial centers participating in the clinical trial;
b) sending, upon verifying compliance in a), electronic notifications to a plurality of reviewers of the availability of the medical data for review by the reviewers;
c) collecting reports submitted by the reviewers via an electronic form, wherein the review reports comprise answers of the reviewers to a common predetermined set of diagnosis questions about the medical data;
d) evaluating the answers in the review reports, for concordance; and
e) transmitting at least one electronic notification pertaining to a result obtained from the evaluating,
wherein at least one of the verifying, sending, collecting, evaluating, and transmitting is performed using at least one processor.

2. The method of claim 1, wherein the verifying comprises at least one of checking for compliance with a pre-selected digital communication requirement, checking for patient file anonymity compliance, checking for compliance with at least one pre-selected diagnosis equipment and/or operational requirement, and checking for compliance with a time-frame reporting requirement for reporting acquired medical data for the clinical trial.

3. The method of claim 1, further comprising operating at least one computer processor to display at least one user interface on a display of a remote data entry device that is configured to provide a user access to at least one clinical trial function via the at least one user interface.

4. The method of claim 3, wherein the at least one clinical trial function includes medical data processing, electronic transmission of medical data, patient data entry, medication dispensation/treatment data entry, clinical endpoint adjudication, and training module access.

5. The method of claim 3, further comprising:
prompting the user for identifying information;
receiving identifying information from the user; and
configuring the user interface, based at least in part, on the identifying information.

6. The method of claim 1, wherein the medical data comprises imaging data.

7. The method, of claim 1, wherein the medical data comprises a positron emission tomography (PET) image, a magnetic resonance image (MRI), a computer axial tomography scan (CAT Scan) image, or a sonogram.

8. The method of claim 1, wherein the sending of electronic notifications comprises e-mailing, text messaging, instant messaging, automated voice messaging, or any combinations thereof.

9. The method of claim 1, wherein the transmitting of electronic notifications comprises e-mailing, text messaging, instant messaging, automated voice messaging, or any combinations thereof.

10. The method of claim 1, wherein the transmitting of the at least one electronic notification on a result obtained from the evaluating comprises e-mailing or text messaging to at least one of an investigator or an administrator of the clinical trial.

11. The method of claim 1, wherein the at least one remote computer is a device having a web browser, a microprocessor, a memory, and a display comprising a user interface.

12. The method of claim 1, wherein the processor comprises a memory, the transmitting comprises electronically transmitting the electronic notification, and the method further comprises storing the electronic notification in the memory.

13. A computerized method for managing a clinical trial, comprising:
a) accessing a gateway to a server computer on a computer system via the Internet from at least one remote client computer having a web browser, wherein the server computer comprises a processor operable to run a program loadable on the processor for managing workflow of a clinical trial, wherein the clinical trial involves a plurality of physically separate sites from which imaging study images obtained on patients in the clinical trial are to be generated for image and diagnosis exchange;
b) inputting details at the server computer to configure a workflow program for a clinical trial to be managed on the computer;
c) designating users for the workflow program under different categories of users, each category of user being granted different respective categories of access to the workflow program;
d) populating patient lists for the workflow program;
e) calibrating image quality control for the clinical trial to be managed using the workflow program;
f) configuring QA (Quality Assurance before study onset) and QC (Quality Control during clinical trial) requirements related to calibrating image quality in every single site participating to the clinical trial;
g) uploading an imaging study by logging into the gateway to the server computer;
h) auditing an imaging study uploaded to the workflow program in real time, to determine a successful imaging study submission, wherein the auditing comprises at least one procedure of checking digital communication in medicine compliance, checking patient file anonymity, checking protocol compliance, and checking time-frame of reporting;
i) sending, upon determining a successful imaging study submission in step h), notifications to designated image reviewers, designated laboratory users, contract research organization users, a principal investigator, a workflow administrator, or any combinations thereof;
j) logging into the gateway to the server computer, by each of the notified image reviewers, via the Internet;
k) downloading at least one respective imaging study image by each of the notified image reviewers, onto a respective remote client computer;
l) reviewing, by each of the notified reviewers, the at least one downloaded image using non-specific image viewing software selected by the respective reviewer;
m) inputting, by each of the notified image reviewers, responses into a report form having a preselected question-and-answer format, which is accessed using the workflow program, for data entry capture using a remote client computer having a web browser;
n) evaluating the answers in the report forms of the notified image reviewers for concordance;
o) evaluating a consensus result of the report forms according to rules specified by the clinical trial protocol; and
p) transmitting at least one electronic notification pertaining to the consensus result obtained from the evaluating, to at least one of an investigator or an administrator of the clinical trial.

14. The method of claim 13, wherein the server computer comprises a web server accessed at a URL address.

15. The method of claim 13, wherein the at least one remote client computer is a laptop computer, a desktop computer, a tablet computer, or a smartphone.

16. The method of claim 13, wherein information resulting from at least one of steps b), c), and d) is stored on the server computer in the form of a software template.

17. The method of claim 13, wherein the auditing further comprises prompting a submitter to provide missing data and reviewing missing data supplied in response, for compliance.

18. The method of claim 13, wherein non-compliant imaging study images identified in the auditing are rejected for review.

19. The method of claim 13, wherein the auditing comprises triggering auditing sessions on non-compliant sites.

20. The method of claim 13, wherein the sending of electronic notifications comprises at least one of e-mailing and short message service (SMS) transmitting.

21. The method of claim 13, wherein the evaluating the answers in the report forms comprises continuous monitoring of an agreement level for one or more of the notified image reviewers.

22. The method of claim 13, wherein the evaluating the answers in the report forms comprises identifying unexpected disagreements among the notified image reviewers and transmitting an electronic notification pertaining thereto.

23. The method of claim 13, wherein the evaluating the answers in the report forms comprises automatically checking the answers as at least one of a binary concordance rate and an overall concordance rate, and re-training or substituting a reviewer depending on monitored performance based on a set of pre-selected rules.

24. The method of claim 13, wherein the evaluating the answers in the report forms comprises using an algorithm incorporating at least one agreement coefficient selected from Cohen's kappa coefficient, Fleiss' kappa coefficient, and Krippendorf's alpha coefficient.

25. The method of claim 13, wherein the evaluating the answers in the report forms comprises identifying any unexpected disagreement of one of the reviewers with one or more other of the reviewers and triggering at least one auditing session on a non-compliant reviewer.

26. The method of claim 13, further comprising computing clinical testing site non-compliance, labelling a non-compliant imaging study, and sending a notification to a principal investigator.

27. The method of claim 13, wherein information gathered during the method is available to a clinical trial principal investigator, and the method further comprises sending periodic reports to a principal investigator, each periodic report comprising an average number of patients per site, an average patient clinical trial rate, a site compliance rate, reviewer panel concordance information, a rate of outliers in the reports, and an average report confidence level.

28. A clinical trial management system, comprising:
a server computer comprising at least one processor;
at least one remote client computer having a display and a web browser and which can access the server computer via the Internet,
wherein the at least one processor is operable to generate at least one user interface on a display of a remote data entry device configured to provide a user access to at least one clinical trial function via the at least one user interface, the at least one processor is operable to run a program loadable on the server computer for managing workflow of a clinical trial that comprises a plurality of physically separate sites from which medical data obtained on patients in the clinical trial are generated for data and diagnosis exchange, and the at least one processor is operable to run the program for automatically: a) verifying compliance with pre-determined data collection protocols in real time of at least one type of medical diagnosis data collected on a clinical trial patient from at least one of a plurality of peripheral clinical trial centers participating in the clinical trial; b) sending, upon verifying compliance in a), electronic notifications to a plurality of reviewers of the availability of the medical data for review by the reviewers; c) collecting review reports of the reviewers based on an analysis of the medical data by the reviewers, the review reports comprising answers to a common predetermined set of diagnosis questions about the medical data; d) evaluating the answers for concordance; e) evaluating a consensus according to the rules defined in the clinical trial protocol; and f) transmitting at least one electronic notification pertaining to the consensus result obtained from the evaluating.
